(19) United States
(12) Patent Application Publication
(10) Pub. No.: US 2026/0025668 A1
(43) Pub. Date: Jan. 22, 2026

(54) Methods and Apparatus for Providing an Alternative Communications Path Between a First Base Station and a Spectrum Access System (SAS) Via a Second Base Station

(71) Applicant: Charter Communications Operating, LLC, St. Louis, MO (US)

(72) Inventor: Saran Khalid, Denver, CO (US)

(21) Appl. No.: 18/774,111

(22) Filed: Jul. 16, 2024

(51) Int. Cl. H04W 16/02

(52) U.S. Cl. CPC H04W 16/02

(57) ABSTRACT

An alternative channel for communicating information relating to renewal of a spectrum grant from SAS to a first base station is implemented. This alternative channel provides a communications path to communicate grant status from SAS to first base station, while the first base station's primary communication channel with SAS, which typically involves a domain proxy remains interrupted. The alternative channel includes a second base station and a UE. A selected UE sends a grant renewal request message to SAS for the first base station and receives a response message indicating grant status from the SAS. The grant status is forwarded to the first base station, and if the grant is renewed, the first base station renews the grant transmit expiration time and continues to transmit. This approach reduces potential service outages at the first base station due to lack of awareness of the actual status of the SAS grant.

The present application relates to wireless networks and more particularly to methods and apparatus for increasing the reliability of communications between a base station, e.g., a CBRS gNB, and a spectrum access system (SAS), e.g., via implementation of an alternative communication path to be used in the event of a suspected failure of the traditional communications path.

### BACKGROUND

Multiple System Operators (MSOs) have recently been establishing their own Citizens Broadband Radio Services (CBRS) networks to service their subscriber UEs whenever possible. CBRS networks require registration, e.g., registration of each one or more CBRS base stations, and grant(s), e.g., a spectrum grant to one or more of the registered CBRS base stations from a Spectrum Access System (SAS) for the CBRS network to function. A grant to a CBRS base station is renewed by an SAS via a heartbeat process which involves the CBRS base station receiving a heartbeat signal, e.g., a heartbeat message, sometimes referred to simply as a heartbeat, from the SAS. Traditionally, the heartbeat is communicated using the radios of the CBRS base station and a domain proxy. However, sometimes the communication between a CBRS base station, e.g., a gNB CBRS base station, and a SAS can get interrupted, e.g., due to software upgrades, communication channel changes, outage of the domain proxy, problems with an interface on the CBRS base station, domain proxy or SAS, problems with a communications link along the traditional communications path, or for other reasons. This interruption of the communications between the CBRS base station and the SAS can result in the CBRS base station not receiving a message indicating that the grant is being renewed, and the CBRS base station will stop using the previously granted spectrum since it is unaware that the SAS has renewed the grant. This can result in the CBRS base station being effectively shut down with regard to operations servicing its UEs, and the UEs, operating the CBRS base station will need to transition to another base station, e.g., a mobile network operator (MNO) partner network macro base station, if available. This can result in a degraded quality of experience to the UE subscribers and/or cost increases from the perspective of the MSO UE subscriber and/or MSO.

It is desirable, from the perspective of a MSO operator, which has its own CBRS network including its own CBRS base stations, to keep its subscriber UEs on its own network. Based on the above discussion there is a need for new methods and apparatus to increase the robustness of the communications between CBRS base stations and SAS. In particular, it would be desirable if an alternative communications path between a base station and SAS could be supported in the event of a failure with regard to a primary communications path between the base station and SAS.

### SUMMARY

Methods and apparatus, in accordance with some embodiments of the present invention, provide an alternative channel for renewal of a grant from an SAS to a first base station, e.g., a first CBRS gNB. This alternative channel provides a means to get status of a grant from SAS directly and provide it to the first base station, while its traditional communication channel with SAS, which typically involves a domain proxy remains interrupted and while there are no active UEs at the first base station to assist. In accordance with a feature of some embodiments of the present invention, the alternative channel includes a path which includes a second base station, a user equipment (UE) with a connection manager (CM) at the second base station and a server, e.g., a connection manager (CM) server. In some such embodiments, a UE with CM within the MSO network, which is active at the second base station, will take on the task of getting the status through the MSO's network or MNO's network. The grant status/grant renewal message is delivered, via the UE and the second base station, to the first base station, e.g., first CBRS gNB, and if the grant is renewed, the first base station, e.g., first CBRS gNB, renews the grant expiration and continues to transmit.

Methods and apparatus, in accordance with the present invention, include steps and architecture to support the renewal of a grant via an alternative path, when a first base station, e.g. a first CBRS gNB, and SAS are unable to communicate via the traditional path, e.g. through a domain proxy and when there are no active UEs at the first base station to assist. A CM application on the UE and a CM server play important roles in this alternative method of renewal of grant via an alternative path. In addition, the Xn interface between the first and second base station is used to communicate messages including a grant renewal request and a grant renewal request response.

In some embodiments, the first base station, e.g. first CBRS gNB, detects that a predetermined time to grant expiration has been reached, e.g., indicating that there is a problem with the traditional path between the first base station, e.g. first CBRS gNB, and SAS, and in response sends an upcoming timing expiration notification to its access and mobility management function (AMF). The AMF determines whether or not there is an active UE with CM, which can be used to communicate a grant renewal request to the SAS via an alternative path. If the AMF determines that there are no active UEs at the first base station but there are one or more active UEs at a second base station, which can be used, the AMF selects one of the active UEs at the second base station to be used to send a grant renewal request to the SAS via an alternative path. If the AMF determines that there are not any active UEs with CM, which can be used, the AMF finds the most recently active (but currently inactive) UE with CM, e.g., at the second base station, initiates paging of the most recently active UE and RRC re-connection operations are performed to transition the identified UE into an RRC connected mode.

The AMF or first base station sends a grant renewal request, corresponding to the first base station, to the selected or identified UE with CM, via the second base station, for delivery to the SAS via the connection manager (CM) server. The CM application in the UE decides whether the path is to be via the MSO network or via the MNO network. Subsequently, the UE with CM receives a grant renewal request response from the SAS communicated via the CM server and forwards the grant renewal request response, via the second base station, toward the first base station. If the grant renewal request response is positive, indicating the SAS spectrum grant is renewed, the first base station, e.g. first CBRS gNB renews the transmit expiration time and continues to use the spectrum in the area with the renewed grant.

An exemplary communications method, in accordance with some embodiments, comprises: detecting, at a first base station, reaching a predetermined time to Spectrum Access System (SAS) resource grant expiration); sending, from the first base station, in response to reaching the predetermined time to grant expiration, an upcoming timer expiration message to an AMF; and operating the AMF to identify a UE at a second base station for communicating a grant renewal request on behalf of the first base station to the SAS.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary communications system in accordance with an exemplary embodiment.

FIG. 2A is a first part of a signaling diagram comprising of an exemplary method of operating a communications system in accordance with an exemplary embodiment.

FIG. 2B is a second part of a signaling diagram comprising of an exemplary method of operating a communications system in accordance with an exemplary embodiment.

FIG. 2C is a third part of a signaling diagram comprising of an exemplary method of operating a communications system in accordance with an exemplary embodiment.

FIG. 2D is a fourth part of a signaling diagram comprising of an exemplary method of operating a communications system in accordance with an exemplary embodiment.

FIG. 2E is a fifth part of a signaling diagram comprising of an exemplary method of operating a communications system in accordance with an exemplary embodiment.

FIG. 2 comprises the combination of FIG. 2A, FIG. 2B, FIG. 2C, FIG. 2D and FIG. 2E.

FIG. 3 is a legend, which is used to identify signaling, messaging, information and steps corresponding to different alternative scenarios with respect to the signaling diagrams of FIG. 2.

FIG. 4 is a drawing of an exemplary base station, e.g., a first MSO CBRS gNB base station, in accordance with an exemplary embodiment.

FIG. 5 is a drawing of an exemplary base station, e.g., a second MSO CBRS gNB base station, in accordance with an exemplary embodiment.

FIG. 6 is a drawing of an exemplary user equipment (UE), e.g., a MSO subscriber Dual Subscriber Identity Module (SIM) Dual Standby (DSDS) UE including a connection manager (CM) module, in accordance with an exemplary embodiment.

FIG. 7 is a drawing of an exemplary connection manager (CM) server in accordance with an exemplary embodiment.

FIG. 8 is a drawing of an exemplary core network node, e.g., a device implementing a MSO access and mobility management function (AMF), in accordance with an exemplary embodiment.

FIG. 9 is a drawing of an exemplary spectrum access system (SAS), e.g., a SAS which allocates spectrum, e.g., CBRS spectrum, to base stations, in accordance with an exemplary embodiment.

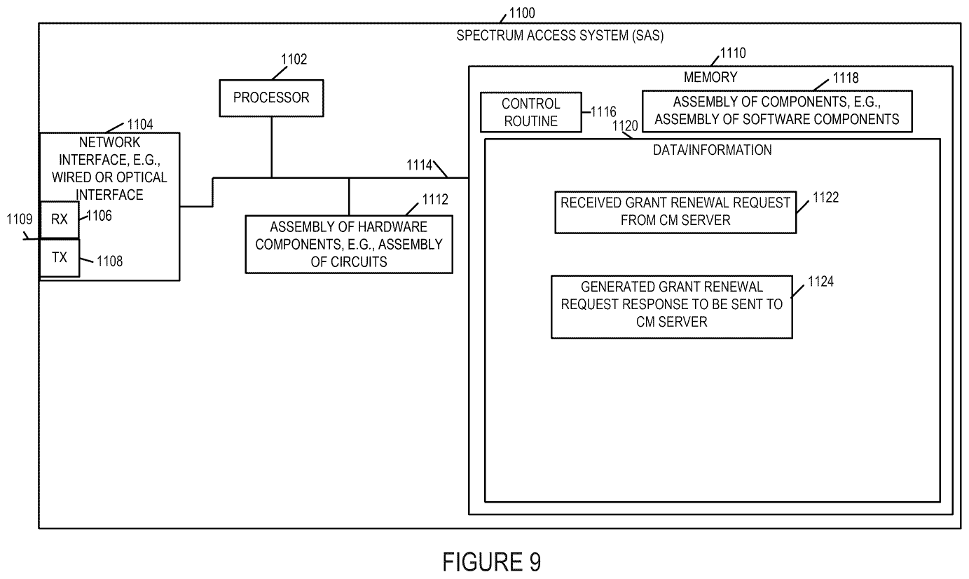

FIG. 10 is a drawing of an exemplary base station, e.g., a MNO macro cell gNB base station, in accordance with an exemplary embodiment.

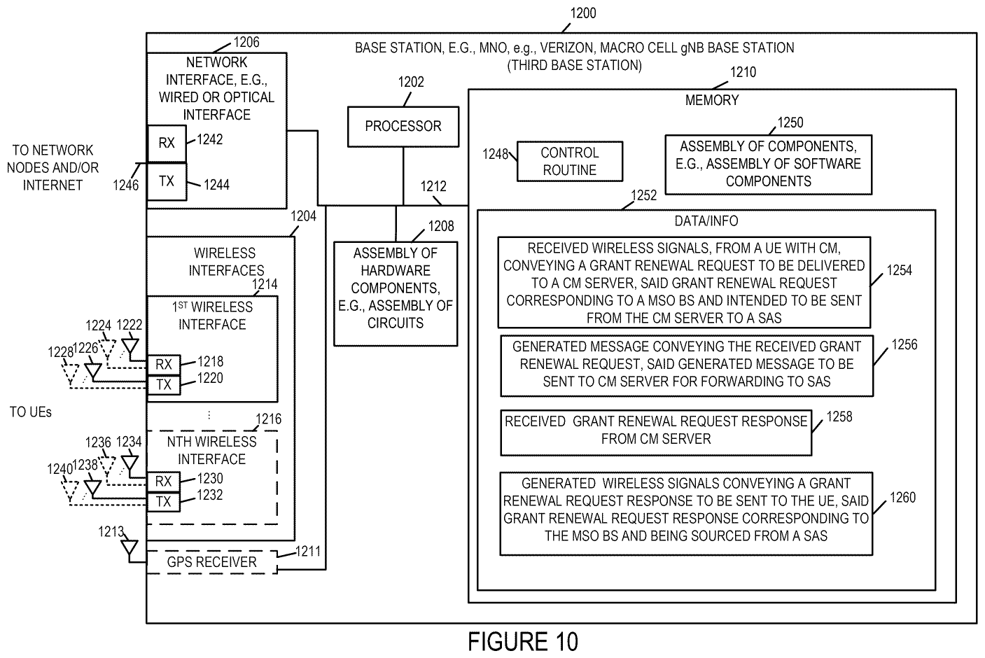

### DETAILED DESCRIPTION

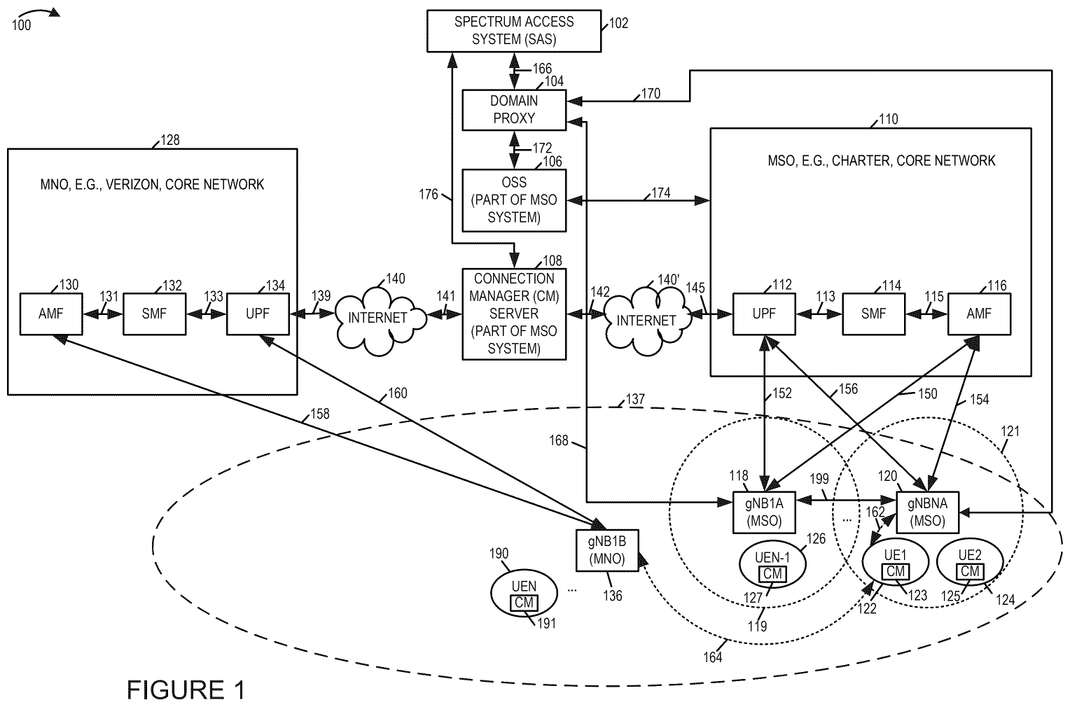

FIG. 1 is a drawing of an exemplary communications system 100 in accordance with an exemplary embodiment. Exemplary communications system 100 includes a spectrum access system (SAS) 102, a domain proxy 104, an operation support system (OSS) 106, a connection manager (CM) server 108, a Multiple-System Operator (MSO), e.g., Charter, core network 110, a Mobile Network Operator (MNO), e.g., Verizon, core network 128, a plurality of MSO base stations (gNB1A 118, . . . , gNBNA 120), e.g., a plurality of Citizens Broadband Radio Services (CBRS) base stations, and a MSO base station (gNB1B 136), e.g., a macro base station, coupled together as shown.

SAS 102 is coupled to domain proxy 104 via communications link 166. SAS 102 is coupled to connection manager server 108 via communications link 176. Domain proxy 104 is coupled to OSS 106 via communications link 172. OSS 106 is coupled to MSO core network 110 via communications link 174. In various embodiments, OSS 106 and CM server 108 are part of the MSO system.

Each of the MSO base stations (gNB1A 118, . . . , gNBNA120), has a corresponding wireless coverage area (119, . . . , 121), respectively. The MNO base station, gNB1B 136, has a corresponding wireless coverage area 137. Exemplary communications system 100 further includes a plurality of user equipments (UE 1 122, UE 2 124, . . . , UEN−1 126, UEN 190) corresponding to the MSO, e.g. Charter. Each of the UEs (122, 124, . . . , 126, 190) includes a corresponding connection manager (CM) module (123, 125, . . . , 127, 191) used for communicating with the CM server 108. In various embodiments, the UEs (122, 124, . . . , 126, 190) are dual SIM dual standby (DSDS) UEs, e.g., including a SIM card corresponding to the MSO and SIM card corresponding to the MNO. In various embodiments, it is desirable that the UEs (122, 124, . . . , 126, 190) use the MSO base stations (118, . . . , 120), whenever adequate service can be provided in accordance with the service agreement and utilize the MNO's base stations as a back-up, e.g., in situations in which MSO service is not available or cannot be provided with adequate QoS.

MSO core network 110 includes a plurality of functions/modules including an access and mobility management function (AMF) 116, a session management function (SMF) 114, and a user plane function (UPF) 112. MNO core network 128 includes a plurality of functions/modules including an access and mobility management function (AMF) 130, a session management function (SMF) 132, and a user plane function (UPF) 134.

MSO gNB1A base station 118, e.g., a CBSD, is coupled to AMF 116 via connection 150 and is coupled to UPF 112 via connection 152. MSO gNBNA base station 120, e.g., a CBSD, is coupled to AMF 116 via connection 154 and is coupled to UPF 112 via connection 156. MSO gNB1A base station 118 is further coupled to domain proxy 104 via communications link 168. MSO gNBNA base station 120 is further coupled to domain proxy 104 via communications link 170. UPF 112 is coupled to CM server 108 via connection 145, Internet portion 140′ and connection 142. UPF 134 is coupled to CM server 108 via connection 139, Internet portion 140 and connection 141. MNO gNB1B base station 136 is coupled to AMF 130 via connection 158. MNO gNB1B base station 136 is coupled to UPF 134 via connection 160. AMF 130 is coupled to SMF 132 via connection 131. SMF 132 is coupled to UPF 134 via connection 133. There may be, and sometimes is a XN connection 199 between MSO gNB1A 118 and MSO gNBNA 120.

At least some of the UEs (UE1 122, UE2 124, . . . UEN−1 126, UEN 190) are mobile devices which may move throughout the system 100 and be connected to different base stations at different times. Exemplary UE1 122 is shown connected to MSO gNBNA base station 120 via wireless communications link 162 and is shown connected to MNO gNB1B base station 136 via wireless communications link 164. In one example, UE1 162 is, e.g., in an active mode or in an inactive mode, and UE2 124, UEN−1 126 and UEN 190 are, e.g., powered off.

Typically, a grant request (for spectrum) and a corresponding grant request response are communicated between MSO gNB1A 118 and SAS 102 via a path including connection 168, domain proxy 104 and connection 166. Heartbeat messages are also communicated along this path. An interface or connection along this path may fail. In accordance with a feature of the present invention, an alternative path between gNB1A 118 and SAS 102 is established and used, said alternative path including an XN connection, e.g. XN connection 199, another MSO gNB base station, e.g., gNBNA 120, a UE including a CM, e.g., UE1 122 including CM 123, and the CM server 108. In some embodiments, MSO 110 includes one or more additional AMFs in addition to AMF 116, e.g., different AMFs corresponding to different regions; and AMF 116 provides communications connectivity to both MSO gNB1A 118 and MSO gNBNA 120, e.g., two adjacent MSO base stations.

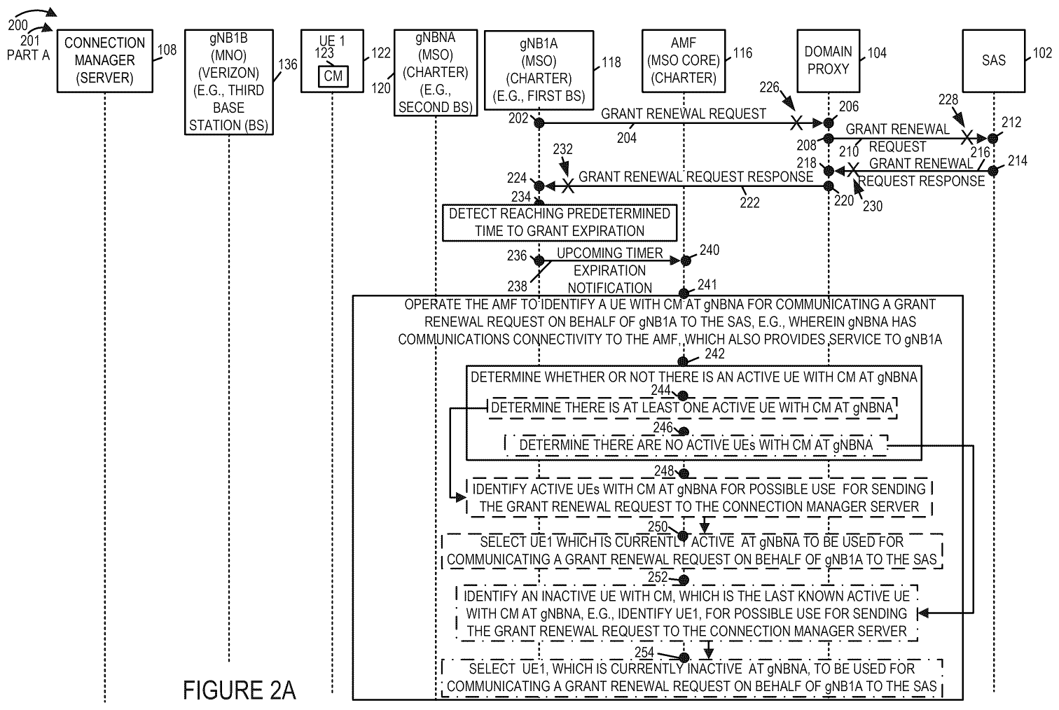

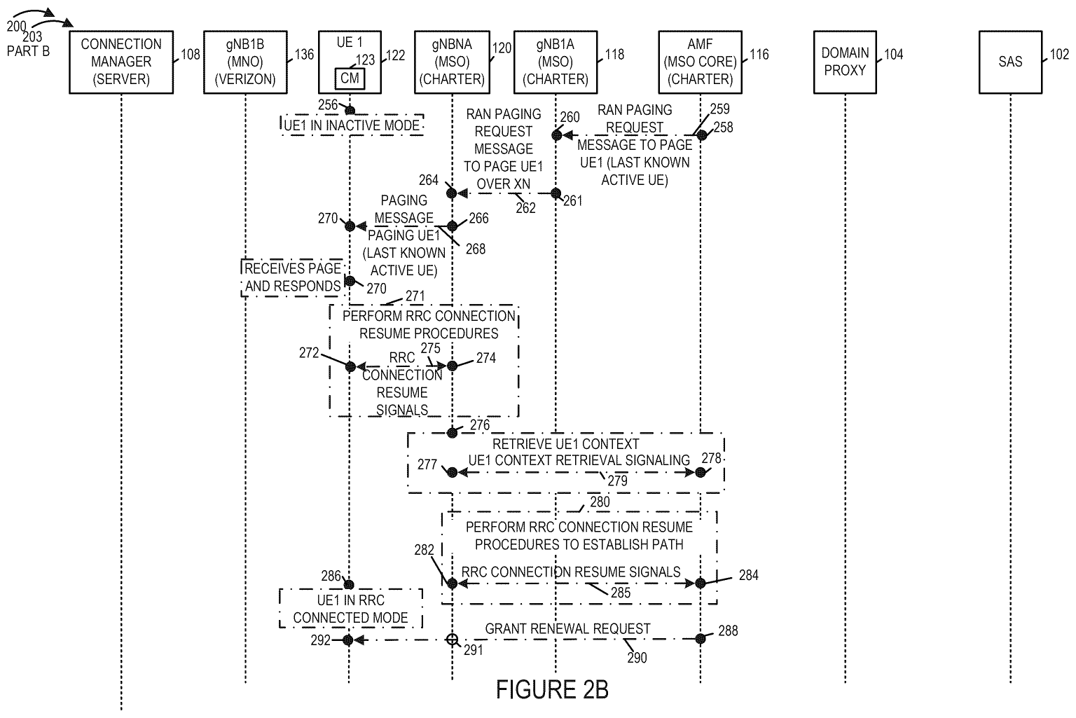

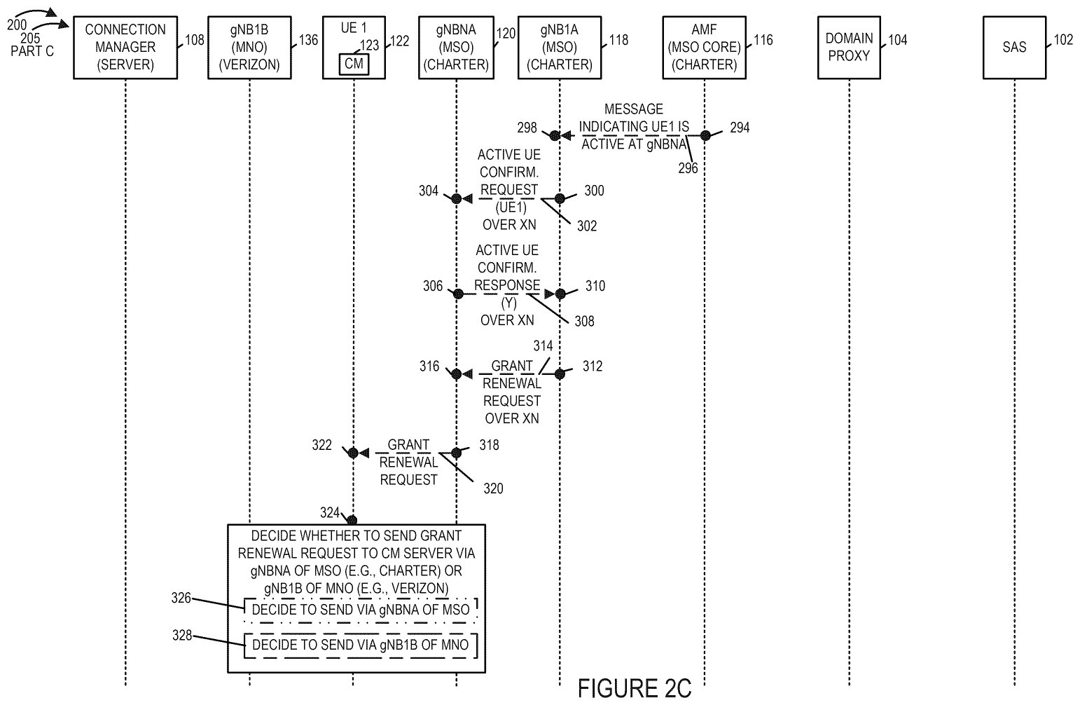

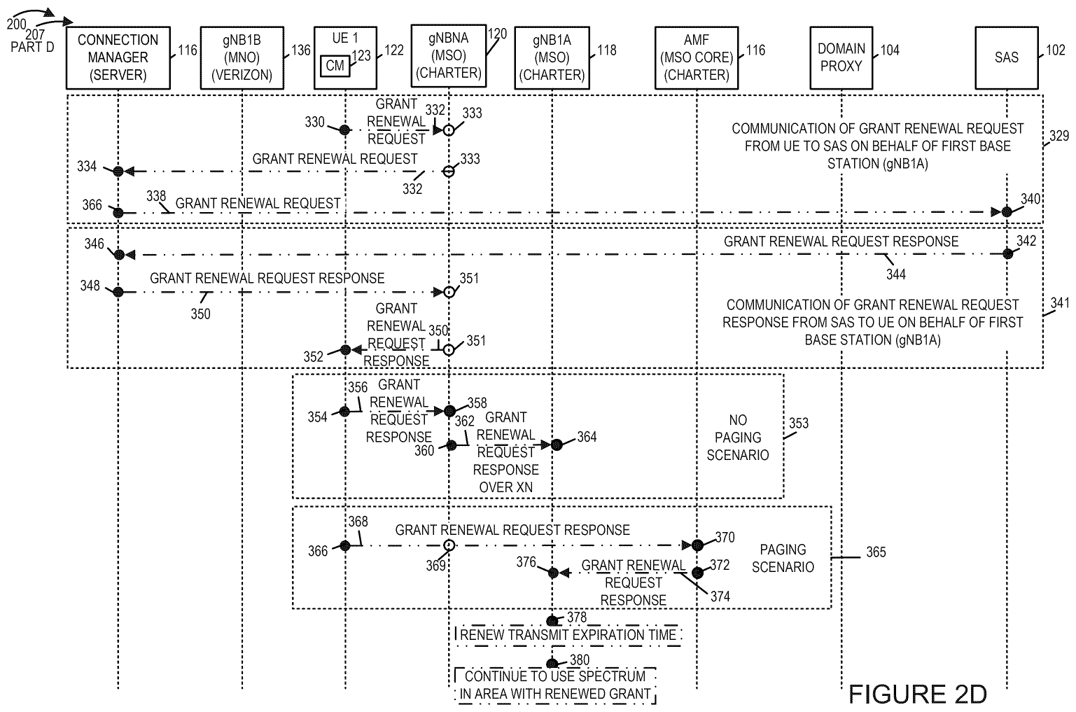

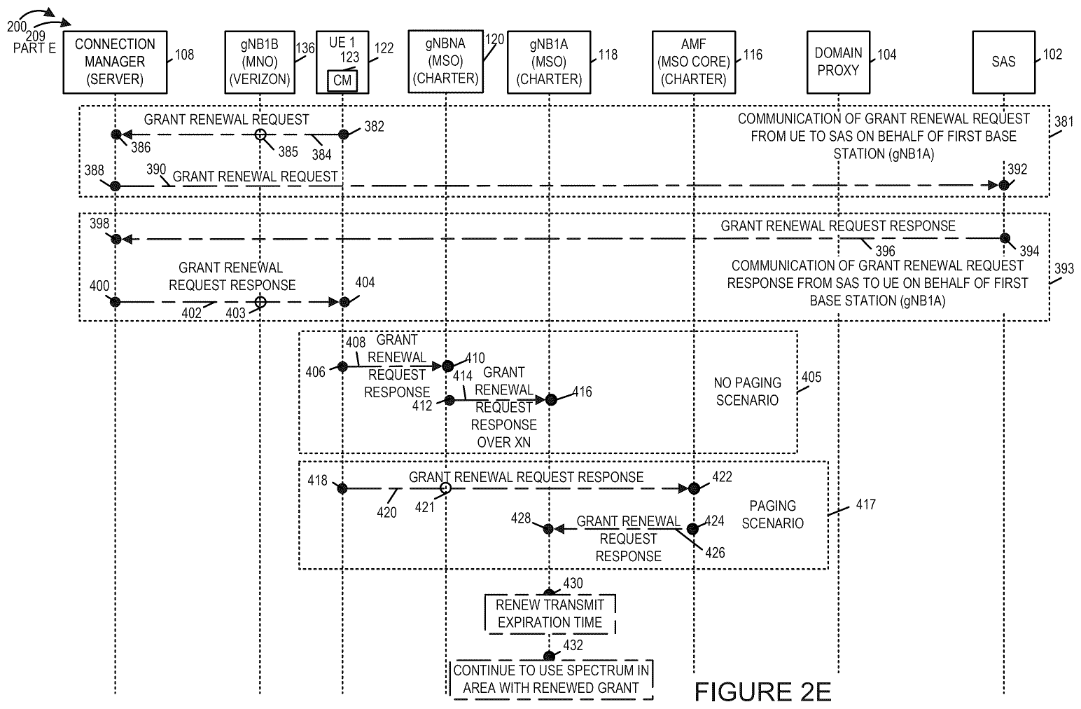

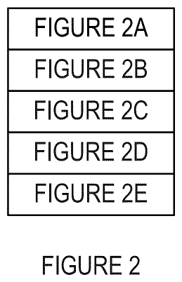

FIG. 2, comprising the combination of FIG. 2A, FIG. 2B, FIG. 2C, FIG. 2D and FIG. 2E, is a signaling diagram 200, comprising Part A 201, Part B 203, Part C 205, Part D 207 and Part E 209, of an exemplary method of operating a communications system 100 in accordance with an exemplary embodiment. FIG. 2 includes connection manager (CM) server 108, MNO gNB1B 136, e.g., a Verizon macro base station, which is sometimes referred to as a third base station (BS), UE 1 122 including CM 123, MSO gNBNA 120, e.g., a Charter CBRS base station, which sometimes referred to as a second base station (BS), MSO gNB1A 118, e.g., a Charter CBRS base station, which sometimes referred to as a first base station (BS), AMF 116, which is one of the AMFs included in the MSO core, domain proxy 104 and SAS 102.

Consider that gNB1A 118 has been previously granted, by SAS 102, spectrum to use. In step 202, gNB1Abase station 118 generates and sends grant renewal request message 204 to domain proxy 104. In step 206, domain proxy 104 may, and generally does, receive grant renewal request 204, and in step 208 domain proxy 104 may, and generally does, forward the received grant renewal request as message 210 to the SAS 102. In step 212 SAS 102 may, and generally does, receive grant renewal request 210 and process the renewal request. Assuming the spectrum is still available to be used by gNB1A 118, the SAS 102, in step 214, may, and generally does, generate and sends a positive grant renewal request response 216 to the domain proxy 104. The domain proxy 104 may, and generally does, receive the grant renewal request response 216 in step 218 and in step 220 send a forwarded copy of the grant renewal request response in message 222 to gNB1A 118. The gNB1A 118 may, and generally does, receive and process the grant renewal request response message 222 in step 224.

There may be a problem along the communications path, e.g., in one of the interfaces of gNB1A 118, of domain proxy 104, or of SAS 102, or in on of the communications links along the path, as indicated by any of X's 226, 228, 230, 232, which results in the gNB1A 118 not receiving a grant renewal request response 222, in response to previously transmitted grant renewal request 204.

In step 234 gNB1A 118 detects reaching a predetermined time to grant expiration, without receiving a grant renewal request response from the SAS 102. In response to the detection of step 234, in step 236, gNB1A 118 generates and sends an upcoming timer expiration notification message 238 to AMF 116. In step 240 AMF 116 receives the upcoming timer expiration notification message 238.

In response to receiving the upcoming timer notification expiration message 238, the AMF 116, in step 241 is operated to identify a UE with CM at gNBNA 120 for communicating a grant renewal request on behalf of gNB1A 118 to the SAS 102, wherein gNBNA 120 has communications connectivity to the AMF 116, which also provides service to gNB1A 118. Step 241 includes steps 242, 248 and 252.

In step 242 AMF 116 determines whether or not there is an active UE with CM at gNBNA 120. Step 242 includes step 244 and step 246, one of which is executed for each iteration of step 242. In step 244 the AMF 116 determines that there is at least one active UE with CM at gNBNA 120. In step 246 the AMF 116 determines that there are no active UEs with CM at gNBNA 120.

Operation proceeds from step 244 to step 248; or alternatively, operation proceeds from step 246 to step 252. In step 248 the AMF 116 identifies active UEs with CM at gNBNA 120 for possible use for sending a grant renewal request, on behalf of gNB1A 118, to the connection manager server 108, e.g., for delivery to SAS 102. For example, the identified active UEs of step 248 include a set of one more UEs which are currently active at gNBNA 120 including UE1 122 with CM 123. Operation proceeds from step 248 to step 250, in which the AMF 116 selects an active UE, e.g. the AMF selects UE1 122 from among the identified active UEs with CM at gNBNA 120, to be used for communicating a grant renewal request on behalf of gNB1A 118 to the SAS 102.

In step 252 the AMF 116 identifies an inactive UE with CM, which is the last known active UE with CM at gNBNA 120, e.g., identifies UE1 122, for possible use for sending a grant renewal request, on behalf of gNB1A 118, to the connection manager server 108, e.g., for delivery to the SAS 102. Operation proceeds from step 252 to step 254, in which the AMF 116 selects UE1 122, which is a currently inactive at gNBNA 120 and which has been identified as the last know active UE with CM at gNBNA 120, to be used for communicating a grant renewal request on behalf of gNB1A 118 to the SAS 102, e.g., via CM server 108. Operation proceeds from step 254 to information block 256, which indicates that UE 1 122 is in inactive mode. Operation proceeds from information block 256 to step 258. In step 258 the AMF 116 generates and sends radio access network (RAN) paging request message 259 to gNB1A 118, requesting paging of UE 1 122, which is the last known active UE at gNBNA 120. In step 260, gNB1A 118 receives the RAN paging message 259, and in step 261 gNB1A 118 generates and sends RAN paging request message 262 over XN to gNBNA 120, requesting paging of UE1 122, which is the last known active UE at gNBNA 120. In step 264 gNBNA 120 receives the RAN paging request message 262, which requests paging of UE1 122, and in response in step 266 gNBNA 120 generates and transmits paging message 268 paging UE1 122.

In step 270 UE1 122, which is in inactive mode, detects paging message 268 and recognizes that it is being paged. In response to the detected paging message 268, UE1 122 and gNBNA 120 in step 271 are operated to perform RRC connection resume procedures. In steps 272 and 274, UE 1 122 and gNBNA 120 are operated, respectively, to communicate RRC connection resume signaling 275. In step 276, gNBNA 120 is operated to retrieve UE1 context, e.g., from the MSO core. In steps 277 and 278 gNBNA 120 and AMF 116, are operated, respectively, to communicate UE1 context retrieval signaling 279.

In step 280 gNBNA 120 and AMF 116 are operated to perform RRC connection resume procedures. In steps 282 and 284, gNBNA 120 and AMF 116 are operated, respectively, to communicate RRC connection resume signaling 285. In step 286, UE1 122 is in RRC connected mode.

Operation proceeds from step 286 to step 288. In step 288 AMF 116 generates and sends grant renewal request 290 (on behalf of gNB1A 118) to UE1 122 via gNBNA. The grant renewal request message 290 is sometimes referred to as a heartbeat request message. The grant renewal request 290 is sent to UE1 122 via gNBNA 120, as indicated by circle 291. In step 292 UE1 122 receives the grant renewal request message 290. Operation proceeds from step 292 to step 324.

Returning to step 250, operation proceeds from step 250 to step 294. In step 294, AMF 116 generates and sends message 296 to gNB1A 118 indicating UE1 122 is an active UE, which may be used to send a grant renewal request on behalf of gNB1A 118 via CM to SAS 102, and UE1 122 is at gNBNA 120. In step 268, gNB1A 118 receives message 296 and recovers the communicated information. In step 300, gNB1A 118 generates and sends active UE confirm request message 302 to gNBNA 120 over XN, said active UE confirm request message 302 requesting gNBNA 120 to confirm that UE1 122 is active at gNBNA 120 and is capable of supporting the grant renewal request to SAS 102 via CM. In step 304, gNBNA 120 receives the gNBNA active UE confirm request 302. In step 306, gNBNA 120 processes the active UE confirm request 302 and generates and sends an active UE confirm response message 308, e.g., indicating a positive response (Y), to gNB1A 118 over XN. In step 310, gNB1A 118 receives the active UE confirm response message 308 and recovers the communicated information. In step 312, gNB1A 118, in response to determining that the received active UE confirm response was positive, generates and sends grant renewal request message 314 over XN to gNBNA 120, said grant renewal request message 314 corresponding to a grant from the SAS 102 to gNB1A 118 to use spectrum.

In step 316 gNBNA 120 receives the grant renewal request message 314, and in response, in step 318, gNBNA 120 generates and sends grant renewal request (on behalf of gNB1A 118) to UE1 122. In step 322 UE 1 122 receives the grant renewal request message 320. Operation proceeds from step 322 to step 324.

In step 324 UE1 122 decides whether to send the grant renewal request (on behalf of gNB1A 118) to the CM server 108 via the gNBNA 120 of MSO (e.g., Charter) or via the gNB1B 136 of MNO (e.g., Verizon). Step 324 includes step 326 in which UE1 122 including CM 123 decides to send the grant renewal request to the CM server 108 via gNBNA 120 of the MSO or step 328 in which UE1 122 including CM 123 decides to send the grant renewal request to the CM server 108 via gNB1B 136 of the MNO. Operation proceeds from step 326 of FIG. 2C to step 330 of FIG. 2D or alternatively, operation proceeds from step 328 of FIG. 2C to step 382 of FIG. 2E.

Returning to step 330, in step 330 UE1 122 generates and sends grant renewal request 332 to CM server 108 via gNBNA 120, as indicated by circle 333. In step 334 the CM server 108 receives the grant renewal request message 332, and in response, in step 336, the CM server 108 generates and sends grant renewal request message 338 (which is forwarded copy of grant renewal request message 332) to SAS 102. In step 340, SAS 102 receives and processes the grant renewal request 338. Block 329, which includes steps 332, 333, 335, 336, 340 and communicated signals/messages 332, 338, shows the communication path of a grant renewal request from UE 1 122 to SAS 102 on behalf of a first base station, which is gNB1A 118. In this example, UE1 122 routes the grant renewal request through a second base station, which is gNBNA 120, e.g., based on the path selection of CM application 123 in UE 122.

In step 342, the SAS 102 generates and sends a grant renewal request response 344 to the CM server 108. The grant renewal request response message 314 is sometimes referred to as a heartbeat message. In step 346 the CM server 108 receives the grant renewal request response 344. In step 348 the connection manager server 108 generates and sends grant renewal request response 350 (which is a forwarded copy of grant renewal request response 354) to UE1 122 including CM 123 via gNBNA 120, as indicated by circle 351. In step 352 UE1 122 receives the grant renewal request response 350. Block 341, which includes steps 342, 346, 348, 351, 352 and communicated signals/messages 344, 350, shows the communication path of a grant renewal request response from SAS 102 to UE1 122 on behalf of a first base station, which is gNB1A 118. In this example, the grant renewal request response is routed through a second base station, which is gNBNA 120.

If the received grant renewal request response 350, is in response to grant renewal request 320 (no paging scenario—request originally sourced from gNB1A 118) then operation proceeds from step 352 to step 354. If the received grant renewal request response 350, is in response to grant renewal request 290 (paging scenario—request originally sourced from AMF 116), then operation proceeds from step 352 to step 366.

Returning to step 354, in step 354 UE1 122 generates and sends grant renewal request response 356 to gNBNA 120. In step 358 gNBNA 120 receives the grant renewal request response 356. In step 360 gNBNA 120 generates and sends grant renewal request response 362, which is a forwarded copy of message 356, to gNB1A 118 over XN. In step 364, gNB1A 118 receives the grant renewal request response 364 and recovers the communicated information, e.g., a positive response indicating that the granted spectrum is being renewed. Block 354, which includes steps 354, 358, 360, 364 and communicated signals/messages 356, 362, shows the communication path of a grant renewal request response from UE 1 122 to the first base station, which is gNB1A 118, for a scenario in which paging was not required to identify UE 1 122, e.g., UE 1 122 was initially an active UE at the second base station gNBNA 120. Operation proceeds from step 364 to step 378.

Returning to step 366, in step 366 UE1 122 generates and sends grant renewal request response 368, via gNBNA 120 as indicated by circle 369, to AMF 116. In step 370 AMF 116 receives the grant renewal request response 368, and in response, in step 372 the AMF 116 generates and sends grant renewal request response 374 (which is a forwarded copy of message 368) to gNB1A 118. In step 376, gNB1A 118 receives the grant renewal request response 374 and recovers the communicated information, e.g., a positive response indicating that the granted spectrum is being renewed. Block 365, which includes steps 366, 369, 370, 372, 376 and communicated signals/messages 368, 374, shows an exemplary communication path of a grant renewal request response from UE 1 122 to the first base station, which is gNB1A 118, for a scenario in which paging was required, e.g., UE 1 122, which was initially inactive at the second base station gNBNA 120, was paged and transitioned into an active state so that it could be used as part of providing an alternative communication path to the SAS. Operation proceeds from step 376 to step 378.

In step 378, gNB1A 118, e.g., in response to receiving a positive response in the grant renewal request response, renews transmit expiration time, and in step 380 gNB1A 118 continues to use spectrum in the area in accordance with the renewed grant.

Returning to step 382 of FIG. 2E, in step 382 UE1 122 generates and sends grant renewal request 384 to CM server 108 via gNB1B 136, as indicated by circle 385. In step 386 the CM server 108 receives the grant renewal request message 384, and in response, in step 388, the CM server 108 generates and sends grant renewal request message 390 (which is forwarded copy of grant renewal request message 384) to SAS 102. In step 392, SAS 102 receives and processes the grant renewal request 390. Block 381, which includes steps 382, 385, 388, 392 and communicated signals/messages 384, 390, shows the communication path of a grant renewal request from UE 1 122 to SAS 102 on behalf of a first base station, which is gNB1A 118. In this example, UE1 122 routes the grant renewal request through a third base station, which is gNB1B 136, e.g., based on the path selection of CM application 123 in UE 122.

In step 394, the SAS 102 generates and sends a grant renewal request response 396 to the CM server 108. The grant renewal request response message 396 is sometimes referred to as a heartbeat message. In step 398 the CM server 108 receives the grant renewal request response 396. In step 400 the connection manager server 108 generates and sends grant renewal request response 402 (which is a forwarded copy of grant renewal request response 396) to UE1 122 including CM 123 via gNB1B 136, as indicated by circle 403. In step 404 UE1 122 receives the grant renewal request response 402. Block 393, which includes steps 394, 398, 400, 403, 404 and communicated signals/messages 396, 402, shows the communication path of a grant renewal request response from SAS 102 to UE1 122 on behalf of a first base station, which is gNB1A 118. In this example, the grant renewal request response is routed through a third base station, which is gNB1B 136.

If the received grant renewal request response 402, is in response to grant renewal request 320 (no paging scenario—request originally sourced from gNB1A 118) then operation proceeds from step 404 to step 406. If the received grant renewal request response 402, is in response to grant renewal request 290 (paging scenario—request originally sourced from AMF 116), then operation proceeds from step 404 to step 418.

Returning to step 406, in step 406 UE1 122 generates and sends grant renewal request response 408 to gNBNA 120. In step 410 gNBNA 120 receives the grant renewal request response 408. In step 412 gNBNA 120 generates and sends grant renewal request response 414, which is a forwarded copy of message 408, to gNB1A 118 over XN. In step 416, gNB1A 118 receives the grant renewal request response 414 and recovers the communicated information, e.g., a positive response indicating that the granted spectrum is being renewed. Block 405, which includes steps 406, 410, 412, 416 and communicated signals/messages 408, 414, shows the communication path of a grant renewal request response from UE 1 122 to the first base station, which is gNB1A 118, for a scenario in which paging was not required to identify UE 1 122, e.g., UE 1 122 was initially an active UE at the second base station gNBNA 120. Operation proceeds from step 416 to step 430.

Returning to step 418, in step 418 UE1 122 generates and sends grant renewal request response 420, via gNBNA 120 as indicated by circle 421, to AMF 116. In step 422 AMF 116 receives the grant renewal request response 420, and in response, in step 422 the AMF 116 generates and sends grant renewal request response 426 (which is a forwarded copy of message 420) to gNB1A 118. In step 428, gNB1A 118 receives the grant renewal request response 426 and recovers the communicated information, e.g., a positive response indicating that the granted spectrum is being renewed. Block 417, which includes steps 418, 421, 422, 424, 428 and communicated signals/messages 420, 428, shows an exemplary communication path of a grant renewal request response from UE 1 122 to the first base station, which is gNB1A 118, for a scenario in which paging was required, e.g., UE 1 122, which was initially inactive at the second base station gNBNA 120, was paged and transitioned into an active state so that it could be used as part of providing an alternative communication path to the SAS. Operation proceeds from step 428 to step 430.

In step 430, gNB1A 118, e.g., in response to the received indication of message 426 that the granted spectrum is being renewed, renews transmit expiration time, and in step 432 gNB1A 118 continues to use spectrum in the area in accordance with the renewed grant.

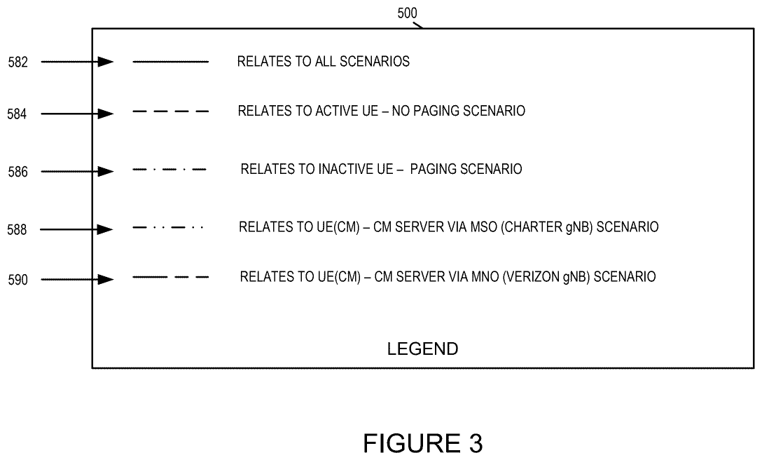

FIG. 3 is a legend 370, which is used to identify signaling, messaging, information and steps corresponding to different alternative scenarios with respect to the signaling diagrams of FIG. 2. Solid lines of type 582 are used to identify signaling, messaging, information and steps relating to all exemplary scenarios. Dashed lines of type 584 are used to identify signaling, messaging, information and steps relating to an identified active UE scenario—a no paging scenario. Dash/single dot lines of type 586 are used to identify signaling, messaging, information and steps relating to an inactive UE scenario—a paging scenario. Dash/double dot lines of type 588 are used to identify signaling, messaging, information and steps relating to UE (with CM)-CM server communication route scenario via MSO (e.g., Charter gNB). Long dash/short dash lines of type 590 are used to identify signaling, messaging, information and steps relating to UE (with CM)-CM server communication route scenario via MNO (e.g., Verizon gNB).

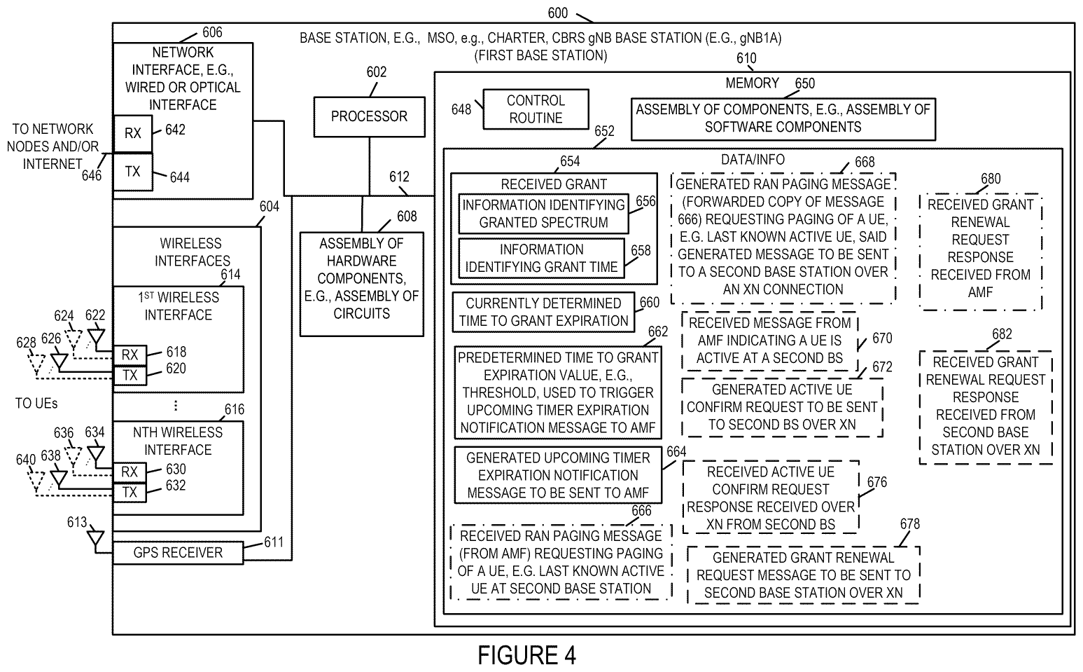

FIG. 4 is a drawing of an exemplary base station 600, e.g., a MSO, e.g., Charter, CBRS gNB base station, in accordance with an exemplary embodiment. Exemplary base station 400 is, e.g., gNB1A base station 118 of FIG. 1 or FIG. 2, which is sometimes referred to as a first base station.

Exemplary base station 600 includes a processor 602, e.g., a CPU, wireless interfaces 604, a network interface 606, an assembly of hardware components 608, e.g., an assembly of circuits, and memory 610 coupled together via bus 612 over which the various elements may interchange data and information. In some embodiments, base station 600 further includes a GPS receiver 611 coupled to bus 612.

Wireless interfaces 604 includes one or more wireless interfaces (1st wireless interface 614, . . . , Nth wireless interface 616). 1st wireless interface 614 includes wireless receiver 618 and wireless transmitter 620. Wireless receiver 618 is coupled to one or more receiver antennas (622, . . . , 624) via which the base station 600 receives wireless uplink signals from UEs. Wireless transmitter 620 is coupled to one or more transmit antennas (626, . . . , 628) via which the base station 600 transmits wireless downlink signals to UEs. In some embodiments one or more antennas are used by both the receiver 618 and transmitter 620. Nth wireless interface 616 includes wireless receiver 630 and wireless transmitter 632. Wireless receiver 630 is coupled to one or more receiver antennas (634, . . . , 636) via which the base station 600 receives wireless uplink signals from UEs. Wireless transmitter 632 is coupled to one or more transmit antennas (638, . . . , 640) via which the base station 600 transmits wireless downlink signals to UEs. In some embodiments one or more antennas are used by both the receiver 630 and transmitter 632. In some embodiments different wireless interfaces correspond to different communications bands, different spectrum, and/or different communications protocols.

Network interface 606, e.g., a wired or optical interface, includes receiver 642, transmitter 644 and connector 646. Network interface 606 couples the base station 600 to network nodes, e.g., other base stations, core network nodes, and a domain proxy, and/or the Internet.

GPS receiver 611 is coupled to GPS receive antenna 613. GPS signals, received via GPS receive antenna 613, are processed by the GPS receiver 611 to determine time, position, e.g. latitude, longitude and altitude, and velocity information. In some embodiment the GPS receiver 611 is used to facilitate a precise placement of the base station 600, e.g., as part of an installation process.

Memory 610 includes a control routine 648, an assembly of components 650 and data/information 652. Control routine 648 includes instructions which when executed by processor 602 control the base station 600 to implement basic operational functions, e.g., read memory, write to memory, control an interface, load a program, subroutine, or app, etc. Assembly of components 650, e.g., an assembly of software components, e.g., routines, subroutines, applications, etc., includes, e.g., code, e.g., machine executable instructions, which when executed by processor 602, controls the base station 600 to implement steps of a method, e.g., steps of the method of signaling diagram 200 of FIG. 2 performed by gNB1A 118.

Data/information 652 includes a received grant from a SAS, said grant allocating CBRS spectrum to base station 600 for a specified time interval. Received grant 654 includes information 656 identifying granted spectrum and information 658 identifying the time for which the grant is valid. Data/information 652 further includes a currently determined time to grant expiration 660, a predetermined time to grant expiration value 662, e.g., a predetermined threshold (e.g. 2 minutes), used to trigger generation and sending of an upcoming timer expiration notification message to an AMF, and a generated upcoming timer expiration message 664 to be sent to an AMF of the MSO. In some embodiments the predetermined time to grant expiration value 662 is a value in the range of 60-200 seconds.

Data/information 652 may, and sometimes does, include a received RAN paging message 666, sent from an AMF, requesting paging of an identified UE, e.g., the last known active UE at another MSO base station, e.g., the last known active UE with CM at gNBNA 120, a generated RAN paging message 668 to be sent over an XN connection to another MSO base station, e.g. gNBNA 120, to request paging of the identified UE, e.g., the last known active UE with CM at gNBNA 120. Data/information 652 further includes a received grant renewal response 680, e.g., sourced from the SAS, e.g., SAS 102, and communicated via an alternative path between the SAS and base station 600, said alternative path including, e.g., a CM server 108, a UE, e.g., UE1 122 with CM, located at a second base station (e.g., gNBNA 120), the second base station, and AMF 116 or XN connection, e.g., XN connection 199, between the second base station and base station 600.

Data/information 652 may, and sometimes does, include a received message 670 from an AMF indicating a UE, e.g., UE1 122, is active at a second base station, e.g., gNBNA 120, a generated active UE confirm request message 672 to be sent to the second BS, e.g., gNBNA 120, over XN, said UE confirm request message 672 requesting the second base station to confirm that an identified UE, e.g., UE1 122, indicated in message 672 is currently active at the second base station, a received active UE confirm response message 670 received over XN from the second base station, e.g., confirming that the UE, e.g., UE1 122 is currently active at the second base station, a generated grant renewal request message 678 to be sent to the second base station over XN, e.g., to be forwarded via the second base station, e.g. gNBNA 120, the identified UE, e.g. UE 122 with CM 123, and a CM server to SAS, on behalf of base station 600, and a received grant renewal request response 682 received from the second base station over a XN connection, said grant renewal request response having originated from the SAS and having been communicated via an alternative communication path with the SAS including a UE with CM, e.g., UE1 122.

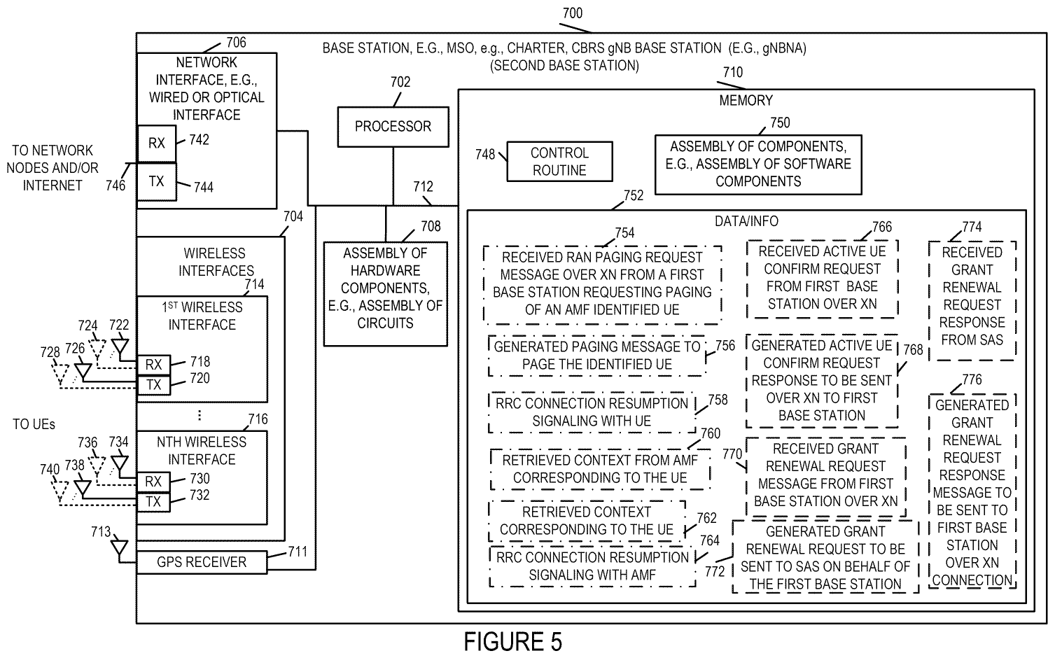

FIG. 5 is a drawing of an exemplary base station 700, e.g., a MSO, e.g., Charter, CBRS gNB base station, in accordance with an exemplary embodiment. Exemplary base station 700 is, e.g., gNBNA base station 120 of FIG. 1 or FIG. 2, which is sometimes referred to as a second base station.

Exemplary base station 700 includes a processor 702, e.g., a CPU, wireless interfaces 704, a network interface 706, an assembly of hardware components 708, e.g., an assembly of circuits, and memory 710 coupled together via bus 712 over which the various elements may interchange data and information. In some embodiments, base station 700 further includes a GPS receiver 711 coupled to bus 712.

Wireless interfaces 704 includes one or more wireless interfaces (1st wireless interface 714, . . . , Nth wireless interface 716). 1st wireless interface 714 includes wireless receiver 718 and wireless transmitter 720. Wireless receiver 718 is coupled to one or more receiver antennas (722, . . . , 724) via which the base station 700 receives wireless uplink signals from UEs. Wireless transmitter 720 is coupled to one or more transmit antennas (726, . . . , 728) via which the base station 700 transmits wireless downlink signals to UEs. In some embodiments one or more antennas are used by both the receiver 718 and transmitter 720. Nth wireless interface 716 includes wireless receiver 730 and wireless transmitter 732. Wireless receiver 730 is coupled to one or more receiver antennas (734, . . . , 736) via which the base station 700 receives wireless uplink signals from UEs. Wireless transmitter 732 is coupled to one or more transmit antennas (738, . . . , 740) via which the base station 700 transmits wireless downlink signals to UEs. In some embodiments one or more antennas are used by both the receiver 730 and transmitter 732. In some embodiments different wireless interfaces correspond to different communications bands, different spectrum, and/or different communications protocols.

Network interface 706, e.g., a wired or optical interface, includes receiver 742, transmitter 744 and connector 746. Network interface 706 couples the base station 700 to network nodes, e.g., other base stations, core network nodes, and a domain proxy, and/or the Internet.

GPS receiver 711 is coupled to GPS receive antenna 713. GPS signals, received via GPS receive antenna 713, are processed by the GPS receiver 711 to determine time, position, e.g. latitude, longitude and altitude, and velocity information. In some embodiment the GPS receiver 711 is used to facilitate a precise placement of the base station 700, e.g., as part of an installation process.

Memory 710 includes a control routine 748, an assembly of components 750 and data/information 752. Control routine 748 includes instructions which when executed by processor 702 control the base station 700 to implement basic operational functions, e.g., read memory, write to memory, control an interface, load a program, subroutine, or app, etc. Assembly of components 750, e.g., an assembly of software components, e.g., routines, subroutines, applications, etc., includes, e.g., code, e.g., machine executable instructions, which when executed by processor 702, controls the base station 700 to implement steps of a method, e.g., steps of the method of signaling diagram 200 of FIG. 2 performed by gNBNA 120.

Data/information 752 may, and sometimes does, include a received RAN paging request message 754 received over XN from a first base station, e.g. gNB1A 118, requesting paging of an AMF identified UE, e.g., UE 122, which is a currently an inactive UE at base station 700 but which was the most recently active UE with CM at base station 700, a generated paging message 758 to be transmitted by base station 700 to page the UE identified in received message 754, RRC connection resumption signaling 758 communicated with the identified UE to reestablish the RRC connection, retrieved context signaling 760 from the AMF corresponding to the UE for which the RRC connection is being reestablished, stored retrieved context 762 corresponding the UE, and RRC connection resumption signaling 764 communicated with AMF as part of the RRC connection reestablishment.

Data/information 752 may, and sometimes does, include a received active UE confirm request message 766 from a first base station, e.g., gNB1A 118, communicated over an XN connection, a generated active UE confirm request response message 768 to be sent over XN to the first base station, e.g. gNB1A 118, a received grant renewal request message 770 received from the first base station, e.g. gNB1A 118, over an XN connection, a generated grant renewal request message 772 to be sent to SAS on behalf of the first base station, e.g. a forwarded copy of message 770, a received grant renewal request response message 774 received from a UE with CM, e.g., UE 122, said grant renewal response message communicating the SAS response to the grant renewal request for the first base station, and a generated grant renewal request response message 776, e.g., a forwarded copy of message 774, to be communicate to the first base station, e.g. gNB1A 118, over an XN connection.

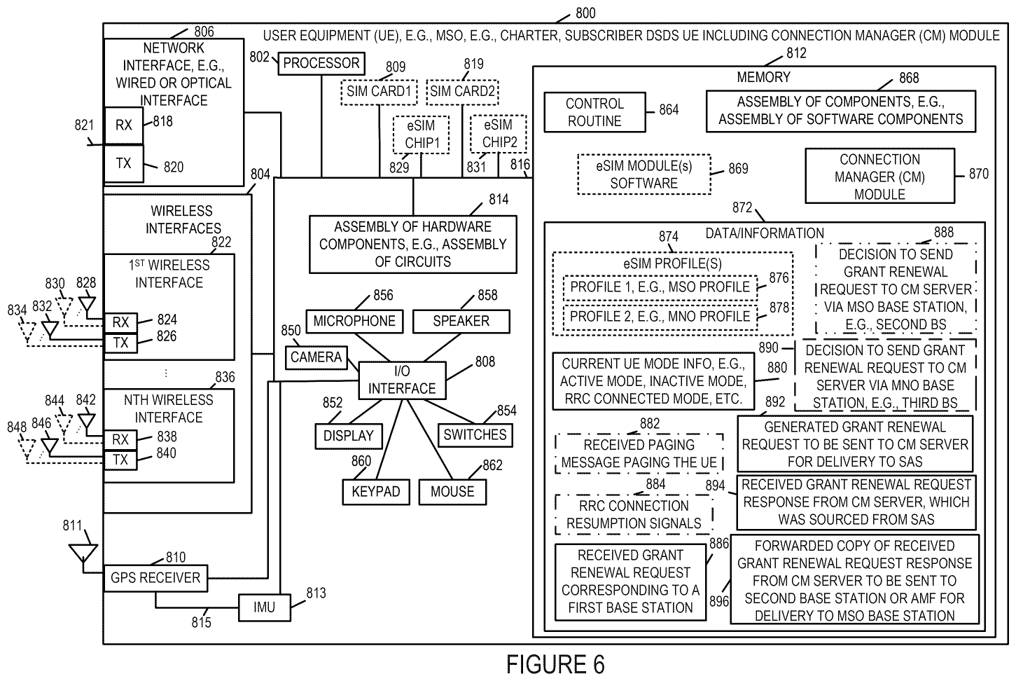

FIG. 6 is a drawing of an exemplary user equipment (UE) 800, e.g., a MSO, e.g., Charter, subscriber Dual Subscriber Identity Module (SIM) Dual Standby (DSDS) UE including a connection manager (CM) module, in accordance with an exemplary embodiment. Exemplary UE 800 of FIG. 5 is, e.g., UE1 122 of FIG. 1 or FIG. 2, UE2 124 of FIG. 1, UEN−1 126 of FIG. 1 or UEN 190 of FIG. 1.

Exemplary UE 800 includes a processor 802, e.g., a CPU, wireless interfaces 804, a network interface 806, e.g., a wired or optical interface, I/O interface 808, GPS receiver 810, inertial measurement unit (IMU) 813, and assembly of hardware components 814, e.g., an assembly of circuits, coupled together via bus 816 over which the various elements may interchange data and information. In various embodiments, UE 800 further includes one or more or all of: SIM card 1 809, SIM card 2 819, eSIM chip 1 829 and eSIM chip 2 831 coupled to bus 816. In some embodiments UE 800 includes 2 SIM cards (809, 819). In some embodiments, UE 800 includes one SIM card, e.g., SIM card 1 809 and one eSIM chip, e.g. eSIM chip 1 829. In still other embodiments, UE 800 includes 2 eSIM chips (eSIM chip 1 829, eSIM chip 2 831). In some embodiments UE 800 includes one SIM card, e.g., corresponding to a MSO, and one eSIM chip, e.g. with a loaded profile corresponding to a MNO.

Wireless interfaces 804 includes a plurality of wireless interfaces (1st wireless interface 822, . . . , Nth wireless interface 836). 1st wireless interface 822 includes wireless receiver 824 and wireless transmitter 826. Wireless receiver 824 is coupled to one or more receiver antennas (828, . . . , 830) via which the UE 800 receives wireless downlink signals from base stations. Wireless transmitter 826 is coupled to one or more transmit antennas (832, . . . , 834) via which the UE 800 transmits wireless uplink signals to base stations. In some embodiments one or more antennas are used by both the receiver 824 and transmitter 826. Nth wireless interface 836 includes wireless receiver 838 and wireless transmitter 840. Wireless receiver 838 is coupled to one or more receive antennas (842, . . . , 844) via which the UE 800 receives wireless downlink signals from base stations. Wireless transmitter 840 is coupled to one or more transmit antennas (846, . . . , 848) via which the UE 800 transmits wireless uplink signals to base stations. In some embodiments one or more antennas are used by both the receiver 838 and transmitter 840. In some embodiments different wireless interfaces correspond to different communications bands, different spectrum, and/or different communications protocols.

Network interface 806, e.g., a wired or optical interface, includes receiver 818, transmitter 820 and connector 821. Network interface 806 may, and sometimes does, couple UE 800 to base stations, network nodes and/or the Internet, e.g., when the UE 800 is stationary and located at a site with a wireline and/or optical connection.

GPS receiver 810 is coupled to GPS antenna 811. GPS receiver 810 is further coupled to IMU 813, e.g., an IMU on a chip including gyroscopes and accelerometers. GPS signals, received via GPS receive antenna 511, are processed by the GPS receiver 510 to determine time, position, e.g. latitude, longitude and altitude, and velocity information of UE 800. In some embodiments, information from IMU 813, e.g., accelerometer and/or gyroscopes measurements over time, are used, in conjunction with or in place of GPS measurements to determine position, e.g. latitude, longitude and altitude, and velocity information of UE 800.

SIM card 1 809 includes information corresponding to a first communications network operator, e.g. a MSO, e.g., Charter, to which the owner of UE 800 is a subscriber. SIM card 2 819 includes information corresponding to a second communications network operator, e.g. a MNO, e.g., Verizon, which is a partner of the first communications network operator. Each eSIM chip (829, 831) can be, and sometimes is loaded with eSIM module software 869 and a eSIM profile, e.g. profile 1 876, e.g., a MSO profile, or profile 2 878, e.g., a MNO profile. For example, eSIM chip 1 829 may be loaded with profile 1, e.g., a MSO profile, and eSIM chip 2 831 may be loaded with profile 2, e.g., a MNO profile.

UE 800 further includes a plurality of I/O devices (camera 850, display 852, e.g., a touch screen display, switches 854, microphone 856, speaker 858, keypad 860 and mouse 862) coupled to I/O interface 808, which couples the various I/O devices to other elements of the UE 800 via bus 816.

Memory 812 includes a control routine 864, an assembly of components 868, e.g., an assembly of software components, a connection manager (CM) module 870, eSIM module(s) software 869, e.g. to be loaded into e-SIM chip(s), and data/information 872. Control routine 864 includes instructions which when executed by processor 802 control the UE 800 to implement basic operational functions, e.g., read memory, write to memory, control an interface, load a program, subroutine, or app, etc. Connection manager module 870 interfaces with a CM server, e.g., CM server 108. CM module 870 makes decisions and/or controls a connection between UE 800 and a MSO base station and a connection between UE 800 and a MNO base station. CM module 870 supports DSDS functionality operations. eSIM module(s) software 869, when loaded into an eSIM chip, controls the eSIM chip to perform operations including loading different eSIM profiles at different times and controlling the eSIM chip to function as a SIM card. Assembly of components 868, e.g., an assembly of software components, e.g., routines, subroutines, applications, etc., includes, e.g., code, e.g., machine executable instructions, which when executed by processor 802, controls the UE 800 to implement steps of a method, e.g., steps of the method of signaling diagram 200 of FIG. 2 performed by UE1 122.

Data/information 872 includes eSIM profiles(s) 874 including prolife 1 876, e.g., a MSO profile, and profile 2 878, e.g., a MNO profile. Data/information 872 further includes current UE mode information 880, e.g., indicating active mode, inactive mode, RRC connected mode, etc. Data/information 872 may, and sometimes does includes a received paging message 882 paging UE 800, and RRC connection resumption signals 884. Data/information 872 further includes a received grant renewal request 886 corresponding to a first MSO base station, e.g., originally sourced from a MSO AMF, e.g., AMF 116 on behalf of a first MSO base station, e.g., MSO gNB1A 118, which was communicated to UE 800 via a second MSO base station, e.g., MSO gNBNA 120, to which the UE 800 is attached or alternatively originally sourced from a first MSO base station, e.g., MSO gNB1A 118, which was communicated to UE 800 via a second MSO base station, e.g., MSO gNBNA 120, to which the UE 800 is attached. Data/information 572 may, and sometimes does include information 888 indicating a UE CM decision to send the grant renewal request to the CM server via a MSO base station, said grant renewal request to be communicated from the CM server to the SAS or information 890 indicating a UE CM decision to send the grant renewal request to the CM server via a MNO base station, said grant renewal request to be communicated from the CM server to the SAS. Data/information 872 further includes a generated grant renewal request 892 to be sent to the CM server for delivery to the SAS, said grant renewal request 892 being a forwarded copy of the received grant renewal request 886, a received grant renewal request response 894 from the CM server, indicating the SAS decision with regard to the grant renewal request, and a generated forwarded copy 896 of the received grant renewal request response from the CM server to be sent to the second MSO base station, e.g., gNBNA 120, or AMF, e.g., AMF 116, for intended delivery to the first MSO base station, e.g., gNB1A 118.

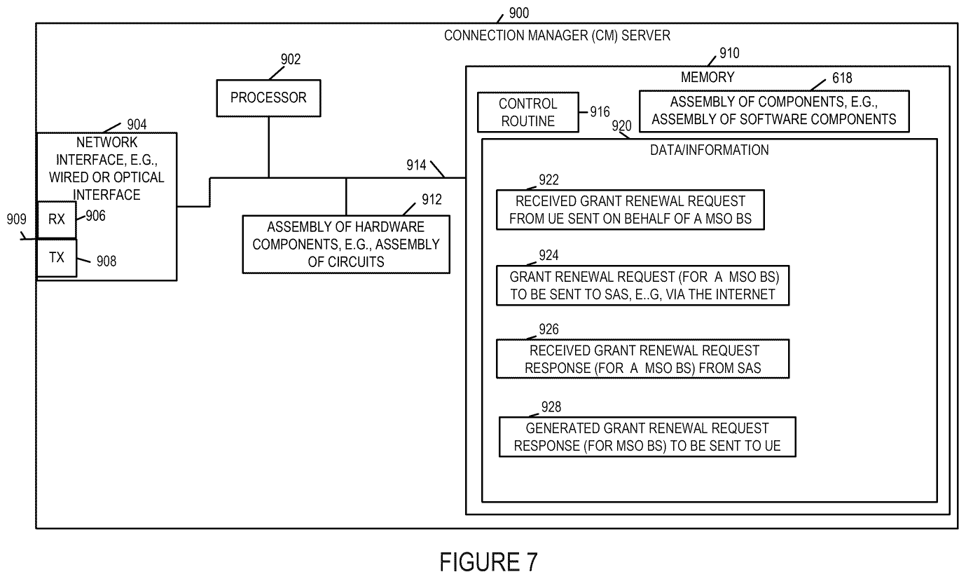

FIG. 7 is a drawing of an exemplary connection manager (CM) server 900 in accordance with an exemplary embodiment. CM server 900 is, e.g., CM server 108 of FIG. 1 or FIG. 2. CM server 900 includes a processor 902, e.g., a CPU, a network interface 904, e.g., a wired or optical interface, memory 910, and an assembly of hardware components 912, e.g., an assembly of circuits, coupled together via a bus 914 over which the various elements may interchange data and information.

Network interface 904, e.g., a wired or optical interface, includes receiver 906, transmitter 908 and connector 909. Network interface 904 couples CM server 900 to SAS 102. Network interface 904 further couples the CM server 900 to a CM module in a UE, e.g., CM module 123 in UE1 122, via the Internet, a MSO core network, e.g., MSO core network 110, and a MSO base station, e.g. gNBNA 120. Network interface 904 further couples the CM server 900 to a CM module in a UE, e.g., CM module 123 in UE1 122, via the Internet, a MNO core network, e.g., MNO core network 128, and a MNO base station, e.g. gNB1B 136.

Memory 910 includes a control routine 916, an assembly of components 918 and data/information 920. Control routine 916 includes instructions which when executed by processor 902 control the CM server 900 to implement basic operational functions, e.g., read memory, write to memory, control an interface, load a program, subroutine, or app, etc. Assembly of components 918, e.g., an assembly of software components, e.g., routines, subroutines, applications, etc., includes, e.g., code, e.g., machine executable instructions, which when executed by processor 902, controls the CM server 900 to implement steps of a method, e.g., steps of the method of signaling diagram 200 of FIG. 2 performed by CM server 108. Data/information 920 includes a received grant renewal request 922 from a UE, e.g., UE 122, sent on behalf of a MSO base station, e.g., gNB1A 118, a generated grant renewal request 924 (for a MSO base station, e.g., gNB1A 118) to be sent to the SAS, e.g., via the Internet, a received grant renewal request response 926 (for a MSO base station, e.g., gNB1A 118) from the SAS, and a generated grant renewal request response 928 (for the MSO base station, e.g., gNB1A 118) to be sent to the UE, e.g. UE 122.

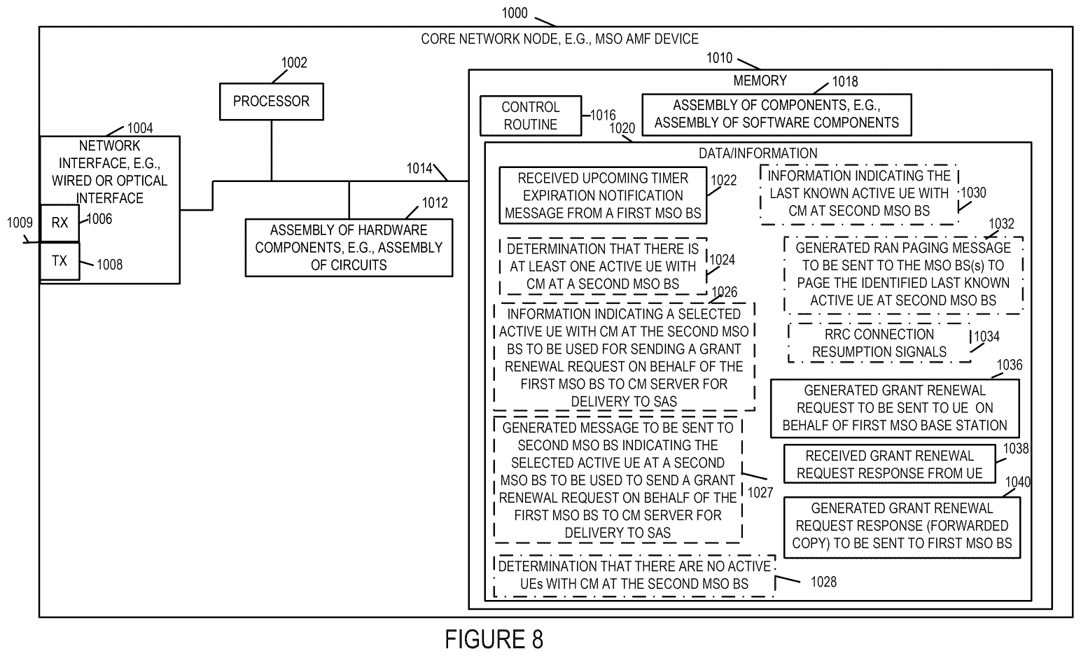

FIG. 8 is a drawing of an exemplary core network node 1000, e.g., a MSO access and mobility management function (AMF) device, in accordance with an exemplary embodiment. Core network node 10000 is, e.g., a device implementing AMF 116 of FIG. 1 or FIG. 2.

Core network node 1000 includes a processor 1002, e.g., a CPU, a network interface 1004, e.g., a wired or optical interface, memory 1010, and an assembly of hardware components 1012, e.g., an assembly of circuits, coupled together via a bus 1014 over which the various elements may interchange data and information.

Network interface 1004, e.g., a wired or optical interface, includes receiver 1006, transmitter 1008 and connector 1009. Network interface 1004 couples core network node 1000 to other core network nodes, to base stations, to an OSS, and to the Internet.

Memory 1010 includes a control routine 1016, an assembly of components 1018 and data/information 1020. Control routine 1016 includes instructions which when executed by processor 1002 control the core network node 1000 to implement basic operational functions, e.g., read memory, write to memory, control an interface, load a program, subroutine, or app, etc. Assembly of components 1018, e.g., an assembly of software components, e.g., routines, subroutines, applications, etc., includes, e.g., code, e.g., machine executable instructions, which when executed by processor 1002, controls the core network node 1000 to implement steps of a method, e.g., steps of the method of signaling diagram 200 of FIG. 2 performed by AMF 116. In some embodiment core network node 1000 implements a plurality of core network functions, e.g., AMF, SMF and UPF.

Data/information 1020 includes a received upcoming timer expiration notification message 1022 from a first MSO base station, e.g., gNB1A 118. In some embodiments, data/information 1020 may, and sometimes does, includes a determination 1024 that there is at least one active UE with CM at a second MSO base station, e.g., gNBNA, information 1026 indicating the selected active UE with CM at the second MSO base station to be used for sending a grant renewal request, on behalf of the first MNO base station, to the CM server for delivery to the SAS, and a generated message 1027 to be sent to the second MSO base station indicating the selected active UE, e.g., UE 122, at the second MSO base station to be used to send a grant renewal request on behalf of the first MSO base station to a CM server for delivery to SAS. In some embodiments, data/information 1020 may, and sometimes does, includes a determination 1028 that there are no active UEs with CM at a second MSO base station, e.g., gNBNA 120, information 1030 indicating the last known active UE with CM, e.g., UE 122, at the second MSO base station, e.g., gNBNA 120, a generated RAN paging request message 1032 to be sent to one or more MSO base station(s), e.g., gNB1A 118 and gNBNA 120, requesting paging of the last known active UE at the second MSO base station, and RRC connection resumption signals 1034. Data/information 1020 further includes a generated grant renewal request 1036 to be sent to a UE, e.g., UE 122, via the second base station, e.g., via gNBNA 120, on behalf of the first MSO base station, e.g., gNBNA 118, for communication to SAS via CM server, a received grant renewal request response 1038 from the UE conveying the SAS response to the request 1036, and a generated grant renewal request response 1040, which conveys a forwarded copy of the received SAS response 1038, said generated grant renewal request response 1040 to be sent to the first MSO base station, e.g., gNB1A 118, which originally sent the upcoming timer expiration notification message 1022 to the AMF.

FIG. 11 is a drawing of an exemplary spectrum access system (SAS) 1100 in accordance with an exemplary embodiment. SAS 1100 is, e.g., SAS 102 of FIG. 1 or FIG. 2.

SAS 1100 includes a processor 1102, e.g., a CPU, a network interface 1104, e.g., a wired or optical interface, memory 1110, and an assembly of hardware components 1112, e.g., an assembly of circuits, coupled together via a bus 1114 over which the various elements may interchange data and information.

Network interface 1104, e.g., a wired or optical interface, includes receiver 1106, transmitter 1108 and connector 1109. Network interface 1104 couples SAS 1100 to a domain proxy, e.g., domain proxy 104 and to a CM server, e.g., CM server 108, and/or to the Internet.

Memory 1110 includes a control routine 1116, an assembly of components 1118 and data/information 1120. Control routine 1116 includes instructions which when executed by processor 1102 control the SAS 1100 to implement basic operational functions, e.g., read memory, write to memory, control an interface, load a program, subroutine, or app, etc. Assembly of components 1118, e.g., an assembly of software components, e.g., routines, subroutines, applications, etc., includes, e.g., code, e.g., machine executable instructions, which when executed by processor 1102, controls the SAS 1100 to implement steps of a method, e.g., steps of the method of signaling diagram 200 of FIG. 2 performed by SAS 102. Data/information 1120 includes a received grant renewal request 1122 from a CM server, which was sent on behalf of a first MSO base station, which is experiencing communications problems with the SAS when using its normal communications path with the SAS, and a generated grant renewal request response 1124, e.g., indicating that the grant is to be renewed, to be sent to the CM server in response to request 1122, said generated grant renewal request response 1124 intended to be delivered to the first MSO base station, which generated and sent an upcoming timer expiration notification message to the MSO AMF.

FIG. 12 is a drawing of an exemplary base station 1200, e.g., a MNO, e.g. Verizon, macro cell gNB base station, in accordance with an exemplary embodiment. Exemplary base station 1200 is, e.g., gNB1B base station 136 of FIG. 1 or FIG. 2, which is sometimes referred to as a third base station.

Exemplary base station 1200 includes a processor 1202, e.g., a CPU, wireless interfaces 1204, a network interface 1206, an assembly of hardware components 1208, e.g., an assembly of circuits, and memory 1210 coupled together via bus 1212 over which the various elements may interchange data and information. In some embodiments, base station 1200 further includes a GPS receiver 1211 coupled to bus 1212.

Wireless interfaces 1204 includes one or more wireless interfaces (1st wireless interface 1214, . . . , Nth wireless interface 1216). 1st wireless interface 1214 includes wireless receiver 1218 and wireless transmitter 1220. Wireless receiver 1218 is coupled to one or more receiver antennas (1222, . . . , 1224) via which the base station 1200 receives wireless uplink signals from UEs. Wireless transmitter 1220 is coupled to one or more transmit antennas (1226, . . . , 1228) via which the base station 1200 transmits wireless downlink signals to UEs. In some embodiments one or more antennas are used by both the receiver 1218 and transmitter 1220. Nth wireless interface 1216 includes wireless receiver 1230 and wireless transmitter 1232. Wireless receiver 1230 is coupled to one or more receive antennas (1234, . . . , 1236) via which the base station 1200 receives wireless uplink signals from UEs. Wireless transmitter 1232 is coupled to one or more transmit antennas (1238, . . . , 1240) via which the base station 1200 transmits wireless downlink signals to UEs. In some embodiments one or more antennas are used by both the receiver 1230 and transmitter 1232. In some embodiments different wireless interfaces correspond to different communications bands, different spectrum, and/or different communications protocols.

Network interface 1206, e.g., a wired or optical interface, includes receiver 1242, transmitter 1244 and connector 1246. Network interface 1206 couples the base station 1200 to network nodes, e.g., other base stations, core network nodes, and a domain proxy, and/or the Internet.

GPS receiver 1211 is coupled to GPS receive antenna 1213. GPS signals, received via GPS receive antenna 1213, are processed by the GPS receiver 1211 to determine time, position, e.g. latitude, longitude and altitude, and velocity information. In some embodiment the GPS receiver 1211 is used to facilitate a precise placement of the base station 1200, e.g., as part of an installation process.

Memory 1210 includes a control routine 1248, an assembly of components 1250 and data/information 1252. Control routine 1248 includes instructions which when executed by processor 1202 control the base station 1200 to implement basic operational functions, e.g., read memory, write to memory, control an interface, load a program, subroutine, or app, etc. Assembly of components 1250, e.g., an assembly of software components, e.g., routines, subroutines, applications, etc., includes, e.g., code, e.g., machine executable instructions, which when executed by processor 1202, controls the base station 1200 to implement steps of a method, e.g., steps of the method of signaling diagram 200 of FIG. 2 performed by gNB1B 136.

Data/information 1252 includes received wireless signals 1254 from a UE with CM, e.g., UE 122 with CM 123, conveying a grant renewal request on behalf of a first MNO base station, e.g. gNB1A 119, to be delivered to a CM server, said grant renewal request intended to be sent from the CM server to a SAS, a generated message 1256 conveying the received grant renewal request, said generated message to be sent to the CM server for forwarding to the SAS, a received grant renewal request response 1258 from CM server conveying the SAS response, and generated wireless signals 1260 conveying the received grant renewal request response, said generated wireless signals to be sent to the UE, said grant renewal request response corresponding to a MSO base station, e.g., a first MSO base station, e.g., gNB1A 118, and being sourced from a SAS.

Various aspects and/or features of the present invention are described below. SAS delivers heartbeat to the nodes, e.g., MSO CBRS gNB base stations, to allow them to continue transmission. If the heartbeat is absent, the cell (gNB CBRS base station) will stop transmitting because the transmit expiration timer will not get updated. This will cause the gNB to stop transmitting and to go out of service.

It is quite possible that sometimes, due to network issues, SAS related issues or a domain proxy/OSS related issue, the heartbeat is not delivered to the radio of a gNB, although gNB operation is permitted from the SAS perspective. Thus, despite having a valid grant, the gNB may, at times, be unable to renew its transmit expiry time and go out of service, i.e. the gNB will stop transmitting.

One way to circumvent the situation is the use of a UE to renew the grant. However, it is possible that the gNB, does not have an active UE in the system and therefore is unable to use its available air link resources to send a grant renewal request to the SAS via an alternative path including a UE, which is wirelessly connected to the gNB. However, it is possible that another cell, e.g., a second base station (second MSO BS), in the vicinity of the cell, e.g. first base station (first MSO base station) which needs to have its grant renewed, has active users, e.g., one or more active UEs are at the second MSO base station, which can be used to help to renew the grant for the first MSO base station.

In accordance with the present invention, methods and apparatus are implemented to provide an alternative means to establish a communications path to SAS to continue the heartbeat reception. In various embodiments, the alternative path includes an active UE at another base station, e.g., the second base station, and messaging communicated over Xn interfaces/connections between the first and second base stations. In some embodiments, an AMF, being used by both the first and second base stations, identifies a currently active UE at the second base station to be used for conveying the grant renewal on behalf of the first base station to the SAS. In some embodiments, an AMF, being used by both the first and second base stations, identifies a most recently active but currently inactive UE at the second base station to be transitioned to an active mode and then used for conveying the grant renewal on behalf of the first base station to the SAS.

In some embodiments, in accordance with the present invention, when a first base station, e.g., a first MSO CBRS gNB base station, stops getting a heartbeat, the first base station will reach out, e.g., via a MSO AMF, to find a UE, e.g., a DSDS UE with CM, that is within reasonable distance, to get help. In situations where UEs are not available at the first base station, e.g. no active UEs and/or no inactive UEs at the first base station, the AMF will identify a candidate UE at the second base station which can be used to communicate the grant renewal request on behalf of the first base station. The selected or identified UE with CM, at the second base station, will reach out, e.g., via the MSO network, a MNO network or a MVNO network, e.g., depending upon the CM alternative path selection, to communicate with SAS and get heartbeat confirmation via an alternative communications path, e.g., a communications path that does not include the domain proxy. In this way, the first base station, e.g. first MSO gNB CBRS base station, can continue to transmit provided its grant has been renewed.

In this exemplary case, described above, it is assumed that the first base station, e.g. first MSO gNB CBRS base station, e.g., a CBSD, is unable to renew the grant via the traditional communications path between the first base station and SAS, which includes a domain proxy, or the first base station is assumed to have expired its timer and unable to communicate with the UEs. In some embodiments, the core, e.g., MSO core AMF, will identify and/or select a UE, e.g., a DSDS UE with CM, at a second base station (e.g., a nearby base station using the same AMF as the first base station), e.g., an active UE with CM at the second base station, and send a message, e.g., grant renewal request message to the identified or selected UE with to be delivered to the SAS via the alternative path. Subsequently, a response message, e.g., a grant renewal request response message, e.g., indicating that the SAS spectrum grant has been renewed for the first base station, will be received by the second base station, said response being sourced from the SAS and being communicated via the alternative communications path including the UE with CM at the second base station, and the response is forwarded from the second base station to the first base station, e.g., first MSO gNB CBRS base station, which is experiencing communications problems along its traditional communications path with the SAS. Thus, the first base station, e.g., first MSO gNB CBRS base station, can continue transmitting using the SAS allocated spectrum and continue servicing UEs, when UEs are within its coverage area.

Various described methods and apparatus are directed to providing an alternative mechanism to renew a spectrum grant, e.g., a CBRS spectrum grant, to a first base station, when a problem occurs along the traditional communications path between the SAS and first base station, and when there is no active user on the expiring grant cell, e.g., a first MSO base station. The alternative mechanism identifies a potential UE at a second cell, e.g., second MSO base station, and uses the identified UE at the second base station to communicate a grant renewal request to the SAS on behalf of the first base station, and to receive a grant renewal request response from the SAS. The second base station interacts with the first base station using Xn interfaces/connections to communicate the grant renewal request and/or grant renewal request response. In this way, the second base station and a UE at the second base station are used to assist the first base station in obtaining the grant renewal request response from the SAS via an alternative path when its traditional communication path between the first base station and SAS is experiencing a problem.

Referring to FIG. 1, the interface between gNB1A 118 and domain proxy 104 (corresponding to connection 168) or between domain proxy 104 and SAS 102 (corresponding to connection 166) or both (corresponding to connections 168 and 166) may go down and be down. This will result in MSO gNB1A 118 not getting the heartbeat sourced from the SAS 102. However, it is very much a possibility that the rest of MSO core interfaces are intact, e.g. the radio of MSO gNB1A 118 could continue to function as normal and provide wireless services to UEs. In this example, there are no active UEs at gNB1A 118, e.g., UEN−1 127 is currently powered down and there are no other UEs, e.g., no active UEs or no powered on UEs, within the coverage area 119 which can assist gNB1A 118 in communicating with SAS via an alternative path.

In some embodiments, if there is an active UE with CM, an active DSDS UE with CM, present within the footprint of gNBNA 120, the methods and apparatus, in accordance with the present invention, provide an alternative route between the SAS 102 and gNB1A 118, e.g., using the active UE, e.g. UE 122 at gNBNA 120, gNBNA 120, and messages communicated via Xn interfaces/connection 199 between the base stations (118, 120).

The gNB1A 118 will detect that there is a lack of grant while the grant expiry time is about to expire and notify the core/OSS, e.g., notify the AMF 116 of MSO core 110. Note that different implementations are possible. Assume that the connection manager (CM) server 108 will be subscribed to OSS 106 for SAS connectivity failure, i.e., only SAS connectivity failure alarm with their codes are forwarded to connection manager.

The AMF 116 will identify an active UE, e.g., UE 122 at gNBNA 120 which can be used to assist and sends a message to gNB1A indicating the selected UE and base station at which it is active, which may be used for assistance. gNB1A 118 will confirm, with gNBNA 120, via Xn interface messages, that the AMF selected UE is still active.

Following positive confirmation, the gNB1A base station 118, will send out a message, e.g., a grant renewal request message via Xn interface to gNBNA 120, requesting that the identified UE, e.g. UE 122, be used to communicate the grant renewal request to SAS 102, said grant renewal request including information, e.g., information identifying the base station gNB1A 118 to which the grant renewal request corresponds and information identifying the SAS spectrum grant to the base station.

The gNB1A 118 grant renewal request information will be sent over the MSO network or the MSO network, e.g. depending upon the CM application 123 in UE 122 selection, to a network entity., e.g., CM server 108, which will translate this information to a SAS friendly format and communicate with SAS 102 to confirm whether or not to renew the grant. This information, e.g., the SAS grant request response indicating whether or not the SAS has renewed the grant, will be conveyed back to gNB1A 118, via a path including UE 122, gNBNA 120, an Xn connection between gNBNA 120 and gNB1A 118.

In the case where the grant is suspended or not renewed the radio in gNB1A 118 will be operated not to transmit; otherwise, the radio in gNBB1A 118 will continue to transmit with the new heartbeat message.

CBRS radios need continuous heartbeat to continue to operate. This heartbeat is received from SAS or Domain Proxy that works on behalf of SAS. A base station, e.g., a gNB CBRS base station, can lose its connectivity with SAS or domain proxy and hence may not be able to renew its grant. However, it is possible that the base station, gNB CBRS base station, does not have an active UE in the system and therefore is unable to use a UE to renew its grant.

In some embodiments, in accordance with the present invention, methods and apparatus implement and use a method which makes use of a radio access network (RAN) paging concept and approach to reach a UE in inactive state to convey the grant related information, e.g., a grant renewal request message, to SAS to confirm availability of the SAS grant, e.g., in a DSDS environment.

In this exemplary scenario, e.g., corresponding to the network architecture of FIG. 1, the cell, e.g. MSO gNB1A 118 base station, with an expiring grant has no powered on UEs within its footprint, e.g., UEN−1 126 is powered down and there are currently no other UEs in its coverage area 119. However, in this scenario consider that there are one or more inactive UEs within coverage area 121 corresponding to gNBNA 120, and UE1 122 is the most recently active UE with CM. An exemplary step in this exemplary method of the present invention includes finding at least one inactive ULE that can help with the renewal of the grant. For example, the MSO AMF 116 identifies the last active UE, e.g., UE 122 with CM 123, within the coverage area of base station 120 and sends a message, e.g., RAN paging message, to trigger the base station 120 to page the identified UE 122. In some embodiments, the RAN paging message is sent from the AMF 116 to gNB1A 118, and then forwarded over an Xn connection to gNBNA 120, which transmits a paging signal to page UE 122. Then, assuming the UE 122 responds to the page, operations are performed to cause RRC re-connection of the UE 122 and transition the ULE 122 to an RRC connected state. Then, the AMF 116 sends a message, e.g., a grant renewal request message, to the UE 122 for delivery to the SAS 102 by an alternative path, e.g., an alternative path which does not include the domain proxy. The AMF 116 subsequently receives a request response message, e.g. a grant renewal request response message, sourced from the SAS 102 communicated via the alternative path including the UE 122, and the AMF 116 forwards received SAS grant renewal request response, e.g., indicating whether or not the grant is renewed, to the base station gNB1A 118.

In the case where the grant is suspended or not renewed the radio in gNB1A 118 will be operated not to transmit; otherwise, in the case where the received message indicates that the grant is renewed the radio in gNBB1A 118 will continue to transmit with the new heartbeat message. The cells, e.g., MSO base stations, are connected to each other via Xn interface, i.e., the base stations can talk to each other over that interface. This allows the cells, e.g. MSO base stations, to communicate and exchange messages to effectively carry out wireless functions.

When a cell, e.g. a first MSO base station such as gNB1A 118, has a transmit expiry timer getting close to expiration, e.g., 60-200 seconds left and the grant has not been renewed, in some embodiments, the radio, e.g., radio of gNB1A 118, will trigger a response, i.e. it will look for an active session, i.e., an active UE, to see if it could be used for data exchange with SAS. In some embodiments, the c plane function of the Xn interface will be used for this purpose, in which the data message sent by the gNB, e.g., gNB1A 118, requesting status on its grant will be forwarded over Xn to another gNB, e.g. gNBNA 120, which has active users. Message transfer capability of c plane function will carry the message.

In some embodiments, a gNB, e.g. gNBNA 120, with active users, will reach out to one of its active DSDS users, e.g., UE 122, and, over the Internet, the active UE, e.g., UE 122, will get the status over the Internet and the gNB, e.g., gNBNA 120, will forward the status (grant) to the gNB, e.g. gNB1A 118, with the expiring grant over Xn interface.

Numbered List of Exemplary Method Embodiments:

Method Embodiment 1. A method comprising: detecting (234), at a first base station (MSO gNB1A 118), reaching a predetermined time to Spectrum Access System (SAS) resource grant expiration (e.g., within 2 minutes of the time that the resource grant will expire (e.g., due to a failure of the first base station (118) to receive a heartbeat message required to maintain an existing resource grant or failure of the SAS (102) to receive a resource grant renewal request required due to the upcoming expiration of an existing resource grant or failure of the first base station (118) to receive a resource grant renewal request response from the SAS (102)) (e.g., due to a failure of the implemented communications path between the SAS (102) and the first base station (118), said implemented communications path including interfaces of the SAS (102), domain proxy (104), and first base station (118) and links between the elements (102, 104, 118)); sending (236), from the first base station (118), in response to reaching the predetermined time to grant expiration, an upcoming timer expiration message (238) to an AMF (MSO AMF 116); and operating (241) the AMF (116) to identify a UE at a second base station (gNBNA 120) (where the second base station (120) has communications connectivity to the AMF (116) that also provides service to the first base station (gNB1A 118) for communicating a grant renewal request on behalf of the first base station (gNB1A 118) to the SAS (102) (e.g., via a server, e.g. connection manager server (108)).

Method Embodiment 1A. The method of Method Embodiment 1, wherein identifying a UE at a second base station includes identifying a UE which has a connection manager application for controlling communication with a connection manager server (116) which has communications connectivity to the SAS (102).

Method Embodiment 1B. The method of Method Embodiment 1A, wherein the identified UE is a dual subscriber identity module (SIM) UE.

Method Embodiment 2. The method of Method Embodiment 1, wherein operating (241) the AMF (116) to identify a UE at a second base station (gNBNA 120) for communicating a grant renewal request on behalf of the first base station includes: operating the AMF (116) to select (250) a UE (e.g., UE1 122) which is currently active at the second base station (e.g., gNBNA 120).

Method Embodiment 3. The method of Method Embodiment 1, wherein operating (241) the AMF (116) to identify a UE at a second base station (gNBNA 120) for communicating a grant renewal request on behalf of the first base station (gNB1A 118) includes: operating the AMF (116) to select (250) a UE (UE1 122) which is currently active at the second base station (gNBNA 120) (and has a connection manager which can connect to the connection manager server (108)).

Method Embodiment 3A. The method of Method Embodiment 3, further comprising: operating the AMF 116 to indicate (294) to the first base station (118) the selected active UE (122) at the second base station (120) which is to be used for communicating the grant renewal request to the SAS (102) (e.g., SAS (102) indicates the selected active UE (122) by communicating a UE identifier and also indicates the second base station, e.g., using an identifier of the second base station, in message (296) which is communicated to the first base station (118)).

Method Embodiment 3B The method of Method Embodiment 3A, further comprising: operating the first base station (118) to communicate (312) a grant renewal request to the second base station via an Xn interface, said grant renewal request seeking renewal by the first base station (118) of SAS granted resources (said grant renewal request message being directed to the first UE (122) for processing by the connection manager application (123) within the first UE (122)).

Method Embodiment 3C. The method of Method Embodiment 3B, further comprising: operating SAS (102) to receive (340 or 392) a grant renewal request communicated from the first UE (122) on behalf of the first base station (118) (e.g., via the connection manager server 116 and a connection between the UE and connection manager server (116), said connection to the connection manager server being either via the second base station (120) or a third base station (136)); and operating the SAS (102) to communicate (342 or 394) a grant renewal request response to the first UE 122 (e.g., by sending a grant renewal request response (344 or 396) via connection manager server (116) and the base station (120 or 136) used as part of the communications path between the UE (122) and connection manager server (108) used to communicate with the SAS (102)).

Method Embodiment 3D. The method of Method Embodiment 3C, further comprising: operating the first UE (122) to communicate (354 or 406) the grant renewal request response to the first base station (118) (e.g. first UE (122) sends grant renewal request response message (356 or 406) to second base station (120) for forwarding (as message 362 or 414) to the first base station (118) via an Xn interface and corresponding Xn connection between the second base station (120) and first base station (118)).

Method Embodiment 3E. The method of Method Embodiment 3B, further comprising: operating the first UE (122) (e.g., under control of the connection manager application (123) in the first UE (122)) to send (330 or 382) the grant renewal request to the SAS (102) (e.g., via the connection manager server (108) and either the second base station (120) or a third base station (136) depending on which available connection the UE (122) selects (e.g., in step 324) to use in communicating the grant renewal request on behalf of the first base station).

Method Embodiment 4. The method of Method Embodiment 1, wherein operating (241) the AMF (116) to identify a UE at a second base station (gNBNA 120) for communicating a grant renewal request on behalf of the first base station (118) includes: operating the AMF (116) to select (252) an inactive UE (UE 1 122) which is a last known active UE with a connection manager that was connected to a base station associated with the AMF (116) (and thus has communications connectivity to the first AMF (116)), said selected UE being a first UE.

Method Embodiment 5. The method of Method Embodiment 4, further comprising: operating the AMF (116) to send (258) a (Radio Access Network) RAN paging request message (259) to initiate paging of the first UE (122) (e.g., the AMF (116) triggers paging of the first UE (122) so that the first UE (122) will transition into an active state in which it can be used for communicating the grant renewal request to the SAS (102) on behalf of the first base station (118)).

Method Embodiment 5A. The method of Method Embodiment 5, wherein the RAN paging request message is sent to the first base station (gNB1A 118)), the method further comprising: operating the first base station (118) to communicate (261) the RAN paging request message to the second base station (120) via an Xn interface.

Method Embodiment 5B. The method of Method Embodiment 5A, further comprising: operating (271) the second base station (120) to reestablish a radio connection with the first UE (122) (e.g., communicate (274) one or more RRC connection resume signals to the first UE (122) as part of a connection re-establishment procedure).

Method Embodiment 6. The method of Method Embodiment 4, further comprising: operating (288) the AMF 116 to communicate a grant renewal request to the first UE (122) on behalf of the first base station (118)) (e.g. the AMF 116 sends a grant renewal request on behalf of the first base station (118) to the second base station (120) for delivery to the first UE (122) which is to then communicate it to the SAS (102) on behalf over the first base station (118) via the connection manager server (108) with the connection manager application (123) on the first UE (122) handling the communication to the connection manager server (108) via an available communications link which can be through either the second base station (120) or a partner network base station (gNB1B 136) through which the connection manager application (123) on the UE (122) can connect to the connection manager server (108)).

Method Embodiment 6AA. The method of Method Embodiment 6, further comprising: operating the first UE (122) to communicate (330 or 382) the grant renewal request corresponding to the first base station (118) to the SAS (102).

Method Embodiment 6AA1. The method of Method Embodiment 6AA, wherein operating the UE operating the first UE (122) to communicate (330 or 382) the grant renewal request corresponding to the first base station (118) to the SAS (102) includes sending (330) the grant renewal request through the second base station (120).

Method Embodiment 6AA2. The method of Method Embodiment 6AA, wherein operating the UE operating the first UE (122) to communicate (330 or 382) the grant renewal request corresponding to the first base station (118) to the SAS (102) includes sending (382) the grant renewal request through a third base station (MNO gNB1B 136).

Method Embodiment 6AB. The method of Method Embodiment 6AA, wherein a connection manager application (123) on the first UE (122) sends the grant renewal request to a connection manager server (108) for forwarding to the SAS (102).

Method Embodiment 6AC. The method of Method Embodiment 6, wherein said first base station (118) is a Citizens Broadband Radio Services (CBRS) base station.

Method Embodiment 6AD The method of Method Embodiment 6AA2, wherein the third base station (136) is a base station of a second network (e.g., partner MNO network which the UE has connectivity to) which is different from a first network (e.g., MSO network operator's own network) in which the first base station (118) and second base station (120) are located.

Method Embodiment 6AF. The method of Method Embodiment 6, wherein the first and second base stations (118, 120) are base stations of a first multi-system operator network (MSO) and wherein the first AMF (116) is an AMF (116) of the MSO operator network.

Method Embodiment 6B. The method of Method Embodiment 6, further comprising: operating the AMF (116) to receive (370 or 422) a grant renewal response from the first UE (122) (e.g., a grant renewal response communicated via the second base station (120); and operating the AMF (116) to communicate (372 or 424) the grant renewal response to the first base station (118) (e.g., the grant renewal response from the SAS (102) received by the first UE (122) corresponding to the grant renewal request sent by the first UE (122) to the SAS (102) on behalf of the first base station (118) is communicated to the first base station (118) by the AMF (116) to thereby notify the first base station (118) of the grant renewal in cases where the SAS (102) renewed the first base station's resource grant).

Method Embodiment 7A. The method of Method Embodiment 1, wherein the first base station (118) is located in a first network (e.g., a MSO network, e.g., Charter network, including small cell CBRS base stations owned by the MSO); and wherein a third base station (136) is located in a second network (e.g., a MNO network, e.g., a Verizon network, including macro cell base stations owned by the MNO, which are allowed to be used by subscriber UEs of the MSO network in accordance with an agreement between the MSO and the MNO).

Method Embodiment 7B. The method of Method Embodiment 1, wherein the first UE (122) is a dual SIM UE; wherein the first base station (118) is located in a first network which the UE (122) can access using a first SIM in the first UE (122); and wherein a third base station (136) is located in a second network which the first UE (122) can access using a second SIM in the first UE (122).

Method Embodiment 7C. The method of Method Embodiment 7B, wherein the first UE (122) is a dual SIM dual standby (DSDS) UE.

Method Embodiment 7D. The method of Method Embodiment 7C, wherein the first and second SIMs are implemented using removable SIM cards.

Method Embodiment 7E. The method of Method Embodiment 7C, wherein the first and second SIMs are implemented using first and second profiles loaded on eSIM chips.

Method Embodiment 7F. The method of Method Embodiment 7C, wherein one of the first and second SIMs is implemented using a removable SIM card, and wherein the other one of the first and second SIMs is implemented using a profile loaded on an eSIM chip.

Method Embodiment 8. The method of Method Embodiment 3A, further comprising: operating the first base station (118) to send (312) a grant renewal request to the second base station (120) via an Xn interface; and operating the first base station (118) to receive (364 or 416) a grant renewal request response from the second base station via the Xn interface.

### Numbered List of Exemplary System Embodiments

System Embodiment 1. A communications system (100) comprising: a first base station (MSO gNB1A 118 or 600) including a first processor (602); and an access and mobility management function (AMF) device (116 or 1000) including a second processor (1002); and wherein said first processor (602) is configured to operate the first base station to: detect (234), at the first base station (MSO gNB1A 118), reaching a predetermined time to Spectrum Access System (SAS) resource grant expiration (e.g., within 2 minutes of the time that the resource grant will expire (e.g., due to a failure of the first base station (118) to receive a heartbeat message required to maintain an existing resource grant or failure of the SAS (102) to receive a resource grant renewal request required due to the upcoming expiration of an existing resource grant or failure of the first base station (118) to receive a resource grant renewal request response from the SAS (102)) (e.g., due to a failure of the implemented communications path between the SAS (102) and the first base station (118), said implemented communications path including interfaces of the SAS (102), domain proxy (104), and first base station (118) and links between the elements (102, 104, 118)); send (236), from the first base station (118), in response to reaching the predetermined time to grant expiration, an upcoming timer expiration message (238) to an AMF (MSO AMF 116); and wherein said second processor (1002) is configured to: operate (241) the AMF (116) to identify a UE at a second base station (gNBNA 120) (where the second base station (120) has communications connectivity to the AMF (116) that also provides service to the first base station (gNB1A 118) for communicating a grant renewal request on behalf of the first base station (gNB1A 118) to the SAS (102) (e.g., via a server, e.g. connection manager server (108)).

System Embodiment 1A. The communications system of System Embodiment 1, wherein said second processor (1002) is configured to: operate the AMF to identify a UE which has a connection manager application for controlling communication with a connection manager server (116) which has communications connectivity to the SAS (102), as part of being configured to operate the AMF to identify a UE at a second base station.

System Embodiment 1B. The communications system of System Embodiment 1A, wherein the identified UE is a dual subscriber identity module (SIM) UE.

System Embodiment 2. The communications system of System Embodiment 1, wherein said second processor (1002) is configured to: operate the AMF (116) to select (250) a UE (e.g., UE1 122) which is currently active at the second base station (e.g., gNBNA 120), as part of being configured to operate (241) the AMF (116) to identify a UE at a second base station (gNBNA 120) for communicating a grant renewal request on behalf of the first base station.

System Embodiment 3. The communications system of System Embodiment 1, wherein said second processor (1002) is configured to: operate the AMF (116) to select (250) a UE (UE1 122) which is currently active at the second base station (gNBNA 120) (and has a connection manager which can connect to the connection manager server (108)), as part of being configured to operate (241) the AMF (116) to identify a UE at a second base station (gNBNA 120) for communicating a grant renewal request on behalf of the first base station (gNB1A 118).

System Embodiment 3A. The communications system of System Embodiment 3, wherein said second processor (1002) is further configured to: operate the AMF (116) to indicate (294) to the first base station (118) the selected active UE (122) at the second base station (120) which is to be used for communicating the grant renewal request to the SAS (102) (e.g., SAS (102) indicates the selected active UE (122) by communicating a UE identifier and also indicates the second base station, e.g., using an identifier of the second base station, in message (296) which is communicated to the first base station (118)).

System Embodiment 3B. The communications system of System Embodiment 3A, wherein said first processor (602) is further configured to: operate the first base station (118) to communicate (312) a grant renewal request to the second base station via an Xn interface, said grant renewal request seeking renewal by the first base station (118) of SAS granted resources (said grant renewal request message being directed to the first UE (122) for processing by the connection manager application (123) within the first UE (122)).

System Embodiment 3C. The communications system of System Embodiment 3B, further comprising: said SAS (102 or 1100) including a third processor (1102) configured to: operate the SAS (102) to receive (340 or 392) a grant renewal request communicated from the first UE (122) on behalf of the first base station (118) (e.g., via the connection manager server 116 and a connection between the UE and connection manager server (116), said connection to the connection manager server being either via the second base station (120) or a third base station (136)); and operate the SAS (102) to communicate (342 or 394) a grant renewal request response to the first UE 122 (e.g., by sending a grant renewal request response (344 or 396) via connection manager server (116) and the base station (120 or 136) used as part of the communications path between the UE (122) and connection manager server (108) used to communicate with the SAS (102)).

System Embodiment 3D. The communications system of System Embodiment 3C, further comprising: said first UE (122 or 800) including a fourth processor (802) configured to: operate the first UE (122) to communicate (354 or 406) the grant renewal request response to the first base station (118) (e.g. first UE (122) sends grant renewal request response message (356 or 406) to second base station (120) for forwarding (as message 362 or 414) to the first base station (118) via an Xn interface and corresponding Xn connection between the second base station (120) and first base station (118)).

System Embodiment 3E. The communications system of System Embodiment 3B, further comprising said first UE (122 or 800) including a third processor (802) configured to: operate the first UE (122) (e.g., under control of the connection manager application (123) in the first UE (122)) to send (330 or 382) the grant renewal request to the SAS (102) (e.g., via the connection manager server (108) and either the second base station (120) or a third base station (136) depending on which available connection the UE (122) selects (e.g., in step 324) to use in communicating the grant renewal request on behalf of the first base station).

System Embodiment 4. The communications system of System Embodiment 1, wherein said second processor (1002) is configured to: operate the AMF (116) to select (252) an inactive UE (UE 1 122) which is a last known active UE with a connection manager that was connected to a base station associated with the AMF (116) (and thus has communications connectivity to the first AMF (116)), said selected UE being a first UE, as part of being configured to operate(241) the AMF (116) to identify a UE at a second base station (gNBNA 120) for communicating a grant renewal request on behalf of the first base station (118).

System Embodiment 5. The communications system of System Embodiment 4, wherein said second processor (1002) is further configured to: operate the AMF (116) to send (258) a (Radio Access Network) RAN paging request message (259) to initiate paging of the first UE (122) (e.g., the AMF (116) triggers paging of the first UE (122) so that the first UE (122) will transition into an active state in which it can be used for communicating the grant renewal request to the SAS (102) on behalf of the first base station (118)).

System Embodiment 5A. The communications system of System Embodiment 5, wherein the RAN paging request message is sent to the first base station (gNB1A 118)), and wherein said first processor (602) is further configured to: operate the first base station (118) to communicate (261) the RAN paging request message to the second base station (120) via an Xn interface.

System Embodiment 5B. The communications system of System Embodiment 5A, further comprising:

said second base station (120 or 700) including a third processor (702) configured to: operate (271) the second base station (120) to reestablish a radio connection with the first UE (122) (e.g., communicate (274) one or more RRC connection resume signals to the first UE (122) as part of a connection re-establishment procedure).

System Embodiment 6. The communications system of System Embodiment 4, wherein said second processor (1002) is further configured to: operate (288) the AMF 116 to communicate a grant renewal request to the first UE (122) on behalf of the first base station (118) (e.g. the AMF 116 sends a grant renewal request on behalf of the first base station (118) to the second base station (120) for delivery to the first UE (122) which is to then communicate it to the SAS (102) on behalf over the first base station (118) via the connection manager server (108) with the connection manager application (123) on the first UE (122) handling the communication to the connection manager server (108) via an available communications link which can be through either the second base station (120) or a partner network base station (gNB1B 136) through which the connection manager application (123) on the UE (122) can connect to the connection manager server (108)).

System Embodiment 6AA. The communications system of System Embodiment 6, further comprising: said first UE (122 or 800) including a third processor (802) configured to: operate the first UE (122) to communicate (330 or 382) the grant renewal request corresponding to the first base station (118) to the SAS (102).

System Embodiment 6AA1. The communications system of System Embodiment 6AA, wherein said third processor (802) is configured to: operate the first UE (122) to send (330) the grant renewal request through the second base station (120), as part of being configured to operate the first UE (122) to communicate (330 or 382) the grant renewal request corresponding to the first base station (118) to the SAS (102).

System Embodiment 6AA2. The communications system of System Embodiment 6AA, wherein said third processor (802) is configured to:

operate the first UE to send (382) the grant renewal request through a third base station (MNO gNB1B 136), as part of being configured to operate the first UE (122) to communicate (330 or 382) the grant renewal request corresponding to the first base station (118) to the SAS (102).

System Embodiment 6AB. The communications system of System Embodiment 6AA, wherein said first UE (122) includes a connection manager application (123); and wherein the connection manager application (123) on the first UE (122) controls the first UE (122) to send the grant renewal request to a connection manager server (108) for forwarding to the SAS (102).

System Embodiment 6AC. The communications system of System Embodiment 6, wherein said first base station (118) is a Citizens Broadband Radio Services (CBRS) base station.

System Embodiment 6AD The communications system of System Embodiment 6AA2, wherein the third base station (136) is a base station of a second network (e.g., partner MNO network which the UE has connectivity to) which is different from a first network (e.g., MSO network operator's own network) in which the first base station (118) and second base station (120) are located.

System Embodiment 6AF. The communications system of System Embodiment 6, wherein the first and second base stations (118, 120) are base stations of a first multi-system operator network (MSO) and wherein the first AMF (116) is an AMF (116) of the MSO operator network.

System Embodiment 6B. The communications system of System Embodiment 6, wherein said second processor (1002) is further configured to: operate the AMF (116) to receive (370 or 422) a grant renewal response from the first UE (122) (e.g., a grant renewal response communicated via the second base station (120); and operate the AMF (116) to communicate (372 or 424) the grant renewal response to the first base station (118) (e.g., the grant renewal response from the SAS (102) received by the first UE (122) corresponding to the grant renewal request sent by the first UE (122) to the SAS (102) on behalf of the first base station (118) is communicated to the first base station (118) by the AMF (116) to thereby notify the first base station (118) of the grant renewal in cases where the SAS (102) renewed the first base station's resource grant).

System Embodiment 7A. The communications system of System Embodiment 1, wherein the first base station (118) is located in a first network (e.g., a MSO network, e.g., Charter network, including small cell CBRS base stations owned by the MSO); and wherein a third base station (136) is located in a second network (e.g., a MNO network, e.g., a Verizon network, including macro cell base stations owned by the MNO, which are allowed to be used by subscriber UEs of the MSO network in accordance with an agreement between the MSO and the MNO).

System Embodiment 7B. The communications system of System Embodiment 1, wherein the first UE (122) is a dual SIM UE; wherein the first base station (118) is located in a first network which the UE (122) can access using a first SIM in the first UE (122); and wherein a third base station (136) is located in a second network which the first UE (122) can access using a second SIM in the first UE (122).

System Embodiment 7C. The communications system of System Embodiment 7B, wherein the first UE (122) is a dual SIM dual standby (DSDS) UE.

System Embodiment 7D. The communications system of System Embodiment 7C, wherein the first and second SIMs are implemented using removable SIM cards (809, 819)

System Embodiment 7E. The communications system of System Embodiment 7C, wherein the first and second SIMs are implemented using first and second profiles (876, 878) loaded on eSIM chips (829, 831).

System Embodiment 7F. The communications system of System Embodiment 7C, wherein one of the first and second SIMs is implemented using a removable SIM card (809), and wherein the other one of the first and second SIMs is implemented using a profile loaded (878) on an eSIM chip (829).

System Embodiment 8. The communications system of System Embodiment 3A, wherein said first processor (602) is further configured to: operate the first base station (118) to send (312) a grant renewal request to the second base station (120) via an Xn interface; and operate the first base station (118) to receive (364 or 416) a grant renewal request response from the second base station via the Xn interface.

Various embodiments are directed to apparatus, e.g., base stations, e.g., MSO CBRS gNB base stations and MNO macro gNB base stations, UEs including CM, servers, e.g. CM servers, core nodes, e.g., AMF core nodes, SAS, Domain Proxies, OSS, sector base stations, such as gNB, ng-eNBs, eNBs, etc. supporting beamforming, UEs, base stations supporting massive MIMO such as CBSDs supporting massive MIMO, network management nodes, access points (APs), e.g., WiFi APs, base stations such as NRU gNB base stations, etc., user devices such as stations (STAs), e.g., WiFi STAs, user equipment (UE) devices, LTE LAA devices, various types of RLAN devices, etc., other network communications devices such as routers, switches, etc., mobile network operator (MNO) base stations (macro cell base stations and small cell base stations) such as a Evolved Node B (eNB), gNB or ng-eNB, mobile virtual network operator (MVNO) base stations such as Citizens Broadband Radio Service Devices (CBSDs), network nodes, MNO and MVNO HSS devices, relay devices, e.g. mobility management entities (MMEs), an AFC system, an Access and Mobility Management Function (AMF) device, servers, customer premises equipment devices, cable systems, network nodes, gateways, cable headend and/or hubsites, network monitoring nodes and/or servers, cluster controllers, cloud nodes, production nodes, cloud services servers and/or network equipment devices. Various embodiments are also directed to methods, e.g., method of controlling and/or operating a base station, e.g. base station, e.g., a MSO CBRS gNB base station, MNO macro gNB base station, a UE including CM, a server, e.g. CM server, a core nodes, e.g., AMF core node, a Domain Proxy, an OSS, a sector base station, such as gNB, ng-eNB, eNB, etc., supporting beamforming, UEs, a base station supporting massive MIMNO such as a CBSD supporting massive MIMO, a network management node, access points (APs), e.g., WiFi APs, base stations such as NRU gNB base stations, etc., user devices such as stations (STAs), e.g., WiFi STAs, user equipment (UE) devices, LTE LAA devices, various types of RLAN devices, network communications devices such as routers, switches, etc., user devices, base stations, e.g., eNB and CBSDs, gateways, servers (HSS server), MMEs, an AFC system, cable networks, cloud networks, nodes, servers, cloud service servers, customer premises equipment devices, controllers, network monitoring nodes and/or servers and/or cable or network equipment devices. Various embodiments are directed to communications networks which are partners, e.g., a MSO network, a MNO network and/or a MVNO network. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements are steps are implemented using hardware circuitry.

In various embodiments nodes and/or elements described herein are implemented using one or more components to perform the steps corresponding to one or more methods, for example, message reception, message generation, signal generation, signal processing, sending, comparing, determining and/or transmission steps. Thus, in some embodiments various features are implemented using components or in some embodiment's logic such as for example logic circuits. Such components may be implemented using software, hardware or a combination of software and hardware.

Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a base station, e.g., MSO CBRS gNB base station, a MNO macro gNB base station, a UE including CM, a server, e.g. CM server, core nodes, e.g., a AMF core node, a SAS, a Domain Proxies, an OSS, a base station, e.g. a sector base station, such as gNB, ng-eNB, eNB, etc., supporting beamforming, a UE, a base station supporting massive MIMO such as a CBSD supporting massive MIMO, a network management device, an access points (AP), e.g., WiFi AP, base stations such as NRU gNB base station, etc., a user device such as a station (STA), e.g., WiFi STA, a user equipment (UE) device, LTE LAA device, etc., an RLAN device, other network communications devices a network communications device such as router, switch, etc., a MVNO base station such as a CBRS base station, e.g., a CBSD, a device such as a cellular base station e.g., an eNB, a MNO HSS server, a MVNO HSS server, a UE device, a relay device, e.g. a MME, a AFC system, etc., said device including a processor configured to implement one, multiple or all of the steps of one or more methods of the invention.

In some embodiments, the processor or processors, e.g., CPUs, of one or more devices, e.g., a base station, e.g. a sector base station, such as gNB, ng-eNB, eNB, etc., supporting beamforming, a UE, a base station supporting massive MIMO such as a CBSD supporting massive MIMO, a network management device, communications nodes such as e.g., access points (APs), e.g., WiFi APs, base stations such as NRU gNB base stations, etc., user devices such as stations (STAs), e.g., WiFi STAs, user equipment (UE) devices, LTE LAA devices, etc., various RLAN devices, network communications devices such as routers, switches, etc., a MVNO base station such as a CBRS base station, e.g. a CBSD, an device such as a cellular base station e.g., an eNB, a MNO HSS server, a MVNO HSS device server, a UE device, a relay device, e.g. a MME, a AFC system, are configured to perform the steps of the methods described as being performed by the communications nodes, e.g., controllers. The configuration of the processor may be achieved by using one or more components, e.g., software components, to control processor configuration and/or by including hardware in the processor, e.g., hardware components, to perform the recited steps and/or control processor configuration.

Accordingly, some but not all embodiments are directed to a device, e.g., a base station, e.g., MSO CBRS gNB base station, a INO macro gNB base station, a UE including CM, a server, e.g. CM server, a core node, e.g., an AMF core node, a SAS, a Domain Proxy, an OSS, a sector base station, such as gNB, ng-eNB, eNB, etc., supporting beamforming, a UE, a base station supporting massive MIMO such as a CBSD supporting massive MIMO, a network management device, an access points (AP), e.g., WiFi AP, a base station such as NRU gNB base station, etc., a user device such as station (STA), e.g., WiFi STA, a user equipment (UE) device, an LTE LAA device, etc., a RLAN device, a network communications device such as router, switch, etc., administrator device, security device, a MVNO base station such as a CBRS base station, e.g. a CBSD, an device such as a cellular base station e.g., an eNB, a MNO HSS server, a MVNO HSS device server, a UE device, a relay device, e.g. a MME, includes a component corresponding to each of one or more of the steps of the various described methods performed by the device in which the processor is included. In some but not all embodiments a device, e.g., a communications node such as a base station, e.g. a sector base station, such as gNB, ng-eNB, eNB, etc., supporting beamforming, a UE, a base station supporting massive MIMO such as a CBSD supporting massive MIMO, a network management device, an access points (AP), e.g., WiFi AP, a base station such as NRU gNB base station, etc., a user device such as a station (STA), e.g., WiFi STA, a user equipment (UE) device, a LTE LAA device, a RLAN device, a router, switch, etc., administrator device, security device, a AFC system, a MVNO base station such as a CBRS base station, e.g., a CBSD, a device such as a cellular base station e.g., an eNB, an MNO HSS server, a MVNO HSS device server, a UE device, a relay device, e.g. a MME, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above.

Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a base station, e.g., a sector base station, such as gNB, ng-eNB, eNB, etc., supporting beamforming, a UE, a base station supporting massive MIMO such as a CBSD supporting massive MIMO, a network management node or device, a communications device such as a communications nodes such as e.g., an access point (AP), e.g., WiFi AP, a base station such as NRU gNB base station, etc., a user device such as a station (STA), e.g., WiFi STA, a user equipment (UE) device, a LTE LAA device, etc., an RLAN device, a network communications device such as router, switch, etc., administrator device, MNVO base station, e.g., a CBSD, an MNO cellular base station, e.g., an eNB or a gNB, a UE device or other device described in the present application. In some embodiments, components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method comprising:
detecting, at a first base station, reaching a predetermined time to Spectrum Access System (SAS) resource grant expiration;
sending, from the first base station, in response to reaching the predetermined time to grant expiration, an upcoming timer expiration message to an AMF; and
operating the AMF to identify a User Equipment (UE) at a second base station for communicating a grant renewal request on behalf of the first base station to the SAS.

2. The method of claim 1, wherein identifying a UE at a second base station includes identifying a UE which has a connection manager application for controlling communication with a connection manager server which has communications connectivity to the SAS.

3. The method of claim 1, wherein operating the AMF to identify a UE at a second base station for communicating a grant renewal request on behalf of the first base station includes:
operating the AMF to select a UE which is currently active at the second base station.

4. The method of claim 1, wherein there are no currently active UEs at the first base station; and
wherein operating the AMF to identify a UE at a second base station for communicating a grant renewal request on behalf of the first base station includes:
operating the AMF to select a UE which is currently active at the second base station.

5. The method of claim 3, further comprising:
operating the AMF to indicate to the first base station the selected active UE at the second base station which is to be used for communicating the grant renewal request to the SAS.

6. The method of claim 1, wherein operating the AMF to identify a UE at a second base station for communicating a grant renewal request on behalf of the first base station includes:
operating the AMF to select an inactive UE which is a last known active UE with a connection manager that was connected to a base station associated with the AMF, said selected UE being a first UE.

7. The method of claim 6, further comprising:
operating the AMF to send a (Radio Access Network) RAN paging request message to initiate paging of the first UE.

8. The method of claim 6, further comprising:
operating the AMF to communicate a grant renewal request to the first UE on behalf of the first base station.

9. The method of claim 8, further comprising:
operating the AMF to receive a grant renewal response from the first UE; and
operating the AMF to communicate the grant renewal response to the first base station.

10. The method of claim 5, further comprising:
operating the first base station to send a grant renewal request to the second base station via an Xn interface; and
operating the first base station to receive a grant renewal request response from the second base station via the Xn interface.

11. A communications system comprising:
a first base station including a first processor; and
an access and mobility management function (AMF) device including a second processor; and
wherein said first processor is configured to operate the first base station to:
detect, at the first base station, reaching a predetermined time to Spectrum Access System (SAS) resource grant expiration;
send, from the first base station, in response to reaching the predetermined time to grant expiration, an upcoming timer expiration message to an AMF; and
wherein said second processor is configured to:
operate the AMF to identify a User Equipment (UE) at a second base station.

12. The communications system of claim 11, wherein said second processor is configured to:
operate the AMF to identify a UE which has a connection manager application for controlling communication with a connection manager server which has communications connectivity to the SAS, as part of being configured to operate the AMF to identify a UE at a second base station.

13. The communications system of claim 11, wherein said second processor is configured to:
operate the AMF to select a UE which is currently active at the second base station, as part of being configured to operate the AMF to identify a UE at a second base station for communicating a grant renewal request on behalf of the first base station.

14. The communications system of claim 11,
wherein there are no active UEs at the first base station; and
wherein said second processor is configured to:
operate the AMF to select a UE which is currently active at the second base station, as part of being configured to operate the AMF to identify a UE at a second base station for communicating a grant renewal request on behalf of the first base station.

15. The communications system of claim 13, wherein said second processor is further configured to:
operate the AMF to indicate to the first base station the selected active UE at the second base station which is to be used for communicating the grant renewal request to the SAS.

16. The communications system of claim 11, wherein said second processor is configured to:
operate the AMF to select an inactive UE which is a last known active UE with a connection manager that was connected to a base station associated with the AMF, as part of being configured to operate the AMF to identify a UE at a second base station for communicating a grant renewal request on behalf of the first base station, said selected UE being a first UE.

17. The communications system of claim 16, wherein said second processor is further configured to:
operate the AMF to send a (Radio Access Network) RAN paging request message to initiate paging of the first UE.

18. The communications system of claim 16, wherein said second processor is further configured to:
operate the AMF to communicate a grant renewal request to the first UE on behalf of the first base station.

19. The communications system of claim 18, wherein said second processor is further configured to:
operate the AMF to receive a grant renewal response from the first UE; and
operate the AMF to communicate the grant renewal response to the first base station.

20. The communications system of claim 15, wherein said first processor is further configured to:
operate the first base station to send a grant renewal request to the second base station via an Xn interface; and
operate the first base station to receive a grant renewal request response from the second base station via the Xn interface.
